(19) United States
(12) Patent Application Publication
(10) Pub. No.: US 2022/0070750 A1
(43) Pub. Date: Mar. 3, 2022

(54) INFORMATION PROCESSING DEVICE, INFORMATION PROCESSING METHOD, AND PROGRAM

(71) Applicant: SONY GROUP CORPORATION, Tokyo (JP)

(72) Inventors: Yasuaki YAMAGISHI, Kanagawa (JP); Kazuhiko TAKABAYASHI, Tokyo (JP)

(73) Assignee: SONY GROUP CORPORATION, Tokyo (JP)

(21) Appl. No.: 17/424,771

(22) PCT Filed: Jan. 24, 2020
(86) PCT No.: PCT/JP2020/002455

§ 371 Date: Jul. 21, 2021

(30) Foreign Application Priority Data
Feb. 8, 2019 (JP) 2019-021939

(51) Int. Cl. H04W 36/18; H04W 36/00; H04W 36/22; H04W 36/02; H04L 29/06

(52) U.S. Cl. CPC H04W 36/18; H04W 36/0016; H04L 65/80; H04W 36/023; H04W 36/22

(57) ABSTRACT

There is provided an information processing device, an information processing method, and a program capable of providing seamless streaming. An Edge-DANE on a Source ME-Host makes a synchronous prefetching request to request pre-reading synchronized with the Edge-DANE on the Source ME-Host to an Edge-DANE on a Target ME-Host that streams content to a DASH-Client via a Target RAN when a handover from a Source RAN to the Target RAN occurs due to a movement of the DASH-Client. The present technology can be applied to, for example, an information processing system that provides seamless streaming.

### TECHNICAL FIELD

The present disclosure relates to an information processing device, an information processing method, and a program, and more particularly to an information processing device, an information processing method, and a program capable of providing seamless streaming.

### BACKGROUND ART

In recent years, there is concern that a processing load on a cloud will increase due to streaming viewing on mobile devices, which is spreading very rapidly. In response to such a concern, as one of measures to alleviate the processing load on the cloud, attention is being paid to load distribution of streaming services using edge computing with resources for networks, calculations, storages, and the like that are distributed to and arranged at edges of a network.

For example, in the edge computing, there is a limitation in which various resources of an individual edge server are smaller than those of a central cloud. Therefore, there is a disadvantage that the allocation, selection, and the like of resources are complicated and the management cost increases. Meanwhile, as the spread of streaming services for high-quality content such as so-called 4K or 8K continues to expand from now on, it is considered that a mechanism to achieve an efficient operation of such edge computing resources will be required.

For example, there is a technology for delivering content using MPEG-Dynamic Adaptive Streaming over HTTP (DASH), which is disclosed in Non-Patent Document 1.

### CITATION LIST

### Non-Patent Document

Non-Patent Document 1: ISO/IEC 23009-1: 2012 Information technology Dynamic adaptive streaming over HTTP (DASH)

### SUMMARY OF THE INVENTION

### Problems to be Solved by the Invention

Incidentally, during the streaming viewing on a mobile device, a handover occurs in which the mobile device transitions from a cell to another cell so as to straddle a boundary between base stations due to a movement of the device (hereinafter referred to as an inter-base station handover). At this time, a use case is assumed in which the environment of a transition destination cell, such as the number of clients included in the cell, the execution state of a service group that provides services to the client group, or the like, is different.

Therefore, even in such a use case involving the occurrence of the inter-base station handover, it is required that a reproduction stream is not interrupted and seamless streaming is possible. Here, the seamless streaming means that the streaming is continued without interruption even in a case where a device moves across cells.

The present disclosure has been made in view of such circumstances, and makes it possible to provide seamless streaming in a use case involving occurrence of an inter-base station handover.

### Solutions to Problems

An information processing device of one aspect of the present disclosure includes a first delivery terminal that streams content to a client terminal via a first network, in which the first delivery terminal makes a synchronous prefetching request to request pre-reading synchronized with the first delivery terminal to a second delivery terminal that streams the content to the client terminal via a second network when a handover from the first network to the second network occurs due to a movement of the client terminal.

An information processing method or a program of one aspect of the present disclosure performed by an information processing device including a first delivery terminal that streams content to a client terminal via a first network or a computer of the information processing device includes making, by the first delivery terminal, a synchronous prefetching request to request pre-reading synchronized with the first delivery terminal to a second delivery terminal that streams the content to the client terminal via a second network when a handover from the first network to the second network occurs due to a movement of the client terminal.

In one aspect of the present disclosure, the first delivery terminal makes the synchronous prefetching request to request the pre-reading synchronized with the first delivery terminal to the second delivery terminal that streams the content to the client terminal via the second network when the handover from the first network to the second network occurs due to the movement of the client terminal.

### BRIEF DESCRIPTION OF DRAWINGS

FIG. 1 is a diagram for describing a use case in which a communication system to which the present technology is applied is expected to be used.

FIG. 2 is a block diagram illustrating a configuration example of an information processing system in a first embodiment.

FIG. 3 is a diagram for describing processing of starting streaming.

FIG. 4 is a diagram illustrating a description example of a Workflow Description.

FIG. 5 is a diagram for describing an application object.

FIG. 6 is a flowchart for describing a first processing example of performing prefetching and the streaming.

FIG. 7 is a flowchart for describing a second processing example of performing the prefetching and the streaming.

FIG. 8 is a diagram for describing a transition of an Edge-DANE due to an inter-base station handover.

FIG. 9 is a diagram illustrating a description example of KeepAlreadyEstablishedIfFailed.

FIG. 10 is a diagram illustrating a description example of DoNotMigrate.

FIG. 11 is a diagram for describing the transition of the Edge-DANE.

FIG. 12 is a diagram illustrating a movement of a DASH-Client from a Source RAN to a Target RAN.

FIG. 13 is a diagram for describing processing of causing the Edge-DANE to transition between ME-Hosts.

FIG. 14 is a diagram for describing a segment flow when a synchronous prefetching request serves as a trigger to start the prefetching.

FIG. 15 is a flowchart for describing a first processing example of performing synchronous prefetching and the streaming.

FIG. 16 is a flowchart for describing the first processing example of performing the synchronous prefetching and the streaming.

FIG. 17 is a diagram for describing a case where the Edge-DANE cannot be started up on an ME-Host as a transition destination due to lack of resources.

FIG. 18 is a diagram illustrating the movement of the DASH-Client from the Source RAN to the Target RAN.

FIG. 19 is a diagram for describing processing in the case where the Edge-DANE cannot be started up on the ME-Host as a transition destination due to the lack of resources.

FIG. 20 is a diagram for describing a case where a transition destination cell cannot be predicted.

FIG. 21 is a diagram illustrating a movement of the DASH-Client from the Source RAN to a Target RAN-A.

FIG. 22 is a diagram for describing processing in the case where the transition destination cell cannot be predicted.

FIG. 23 is a diagram for describing a segment flow when the synchronous prefetching request serves as a trigger to start the prefetching.

FIG. 24 is a diagram for describing processing of ensuring fault tolerance redundancy.

FIG. 25 is a diagram illustrating a movement of the DASH-Client from the Source RAN to the Target RAN-A and a Target RAN-B.

FIG. 26 is a diagram for describing the processing of ensuring the fault tolerance redundancy.

FIG. 27 is a diagram illustrating a description example of the Workflow Description.

FIG. 28 is a diagram for describing a pre-change of the cache state of an Edge-DANE based on a traffic prediction.

FIG. 29 is a diagram illustrating a movement of a DASH-Client from a Source RAN to a Target RAN.

FIG. 30 is a diagram for describing processing of changing in advance the cache state of the Edge-DANE on the basis of the traffic prediction.

FIG. 31 is a diagram illustrating a segment flow when a synchronous adaptive prefetching request serves as a trigger to start prefetching.

FIG. 32 is a diagram for describing processing in a case where adaptive prefetching is performed.

FIG. 33 is a diagram illustrating a description example of a PrefetchTriggerRequest.

FIG. 34 is a diagram illustrating a description example of a PrefetchTriggerRequest message.

FIG. 35 is a block diagram illustrating a configuration example of an embodiment of a computer to which the present technology is applied.

### MODE FOR CARRYING OUT THE INVENTION

Hereinafter, specific embodiments to which the present technology is applied will be described in detail with reference to the drawings.

### Use Case

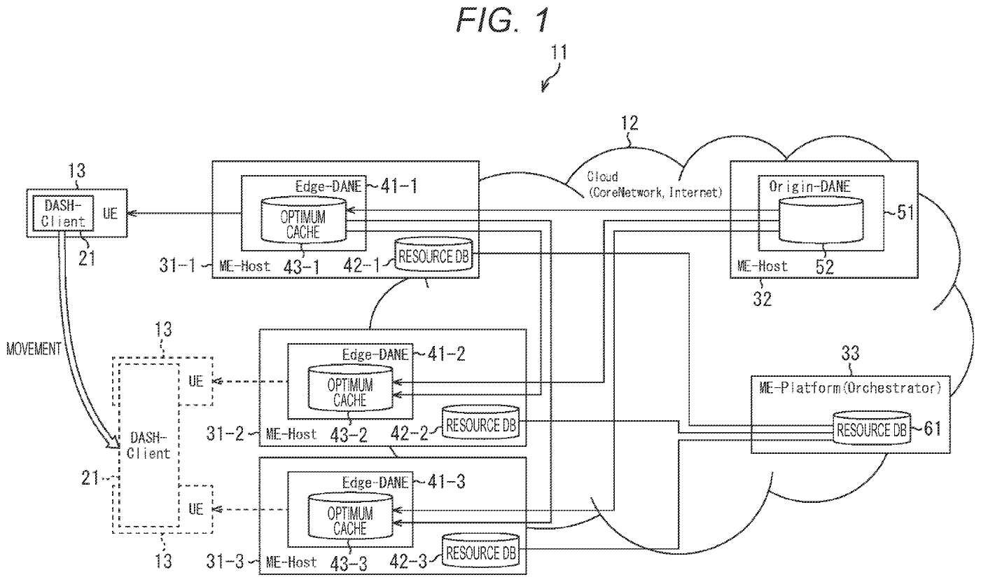

FIG. 1 is a diagram for describing a use case in which an information processing system to which the present technology is applied is expected to be used.

In a configuration example illustrated in FIG. 1, an information processing system 11 includes a cloud 12 and a user terminal 13.

The cloud 12 is configured by connecting a plurality of servers via a network, and each server executes processing to provide various services. For example, in the information processing system 11, the cloud 12 can provide a streaming service that delivers content such as a moving image to the user terminal 13.

As illustrated, the cloud 12 has a configuration in which ME-Hosts 31-1 to 31-3, an ME-Host 32, and an ME-Platform (Orchestrator) 33 are connected via the network. Note that the ME-Hosts 31-1 to 31-3 are each configured in a similar manner, and in a case where it is not necessary to distinguish the ME-Hosts 31-1 to 31-3, the ME-Hosts 31-1 to 31-3 are simply referred to as an ME-Host 31, and each block included in the ME-Host 31 is also referred to in a similar manner. In addition, the ME-Host 31 includes an Edge-DANE 41 and a database holding unit 42, and the database holding unit 42 includes a storage unit 43. Furthermore, the ME-Host 32 includes an Origin-DANE 51, and the Origin-DANE 51 includes a storage unit 52. In addition, the ME-Platform (Orchestrator) 33 includes a database holding unit 61.

As the user terminal 13, for example, a smartphone or the like can be used, and the user terminal 13 can receive and display a moving image delivered by the streaming service from the cloud 12. For example, the user terminal 13 has a configuration in which a DASH-Client 21 is implemented.

Furthermore, a 5G-multi-access edge computing (MEC) architecture is assumed as a network that can be used in such a use case from now on.

Specifically, first, the DASH-Client 21 implemented on the user terminal (user equipment: UE) 13 is connected to an Edge-DANE 41-1 on the ME-Host 31-1. Note that executing a DASH aware network element (DANE) on the ME-Host 31 is a new proposal in the present disclosure.

The Edge-DANE 41-1 is then connected to a general DASH-Origin-Server (not illustrated), which is a root server for DASH streaming, via the Origin-DANE 51 on the ME-Host 32. For example, from the Origin-DANE 51 to the Edge-DANE 41-1, a multi-stage hierarchy may be configured similarly to a server configuration of a general content delivery network (CDN).

For example, the DASH-Client 21 is a streaming reception and reproduction application executed on the user terminal 13 that receives a stream. Furthermore, the Edge-DANE 41 is a streaming transmission application executed on the ME-Host 31 that transmits the stream to the DASH-Client 21.

Note that the Edge-DANE 41 and the Origin-DANE 51 have a function of optimizing the DASH streaming such as caching in advance DASH segments that are likely to be accessed on a side of the individual DASH-Client 21, in addition to functions of a normal Web server, a proxy server, and the like. Therefore, the Edge-DANE 41 and the Origin-DANE 51 have a function of exchanging information necessary for implementing the functions with the DASH-Client 21 (for example, by exchanging DASH-SAND messages).

Incidentally, in a case where the user terminal 13 moves and an inter-base station handover occurs, the Edge-DANE 41-1 executed on the ME-Host 31-1 (MEC environment) bound to a cell before transition also transitions to the ME-Host 31-2 or 31-3 bound to a cell after the transition at the same time. As a result, even if the user terminal 13 moves, the streaming can be performed as seamlessly as possible before and after the movement. In this way, the Edge-DANE 41-1 on the ME-Host 31-1 transitions to an Edge-DANE 41-2 on the ME-Host 31-2 or an Edge-DANE 41-3 on the ME-Host 31-3 bound to the cell after the movement of the user terminal 13, so that the information processing system 11 can take full advantage of MEC computing such as low latency and load distribution.

At this time, if the network traffic of the destination cell and the load status of resources on the ME-Host 31 are known and preparations are made in advance before the inter-base station handover occurs, it can be expected that the streaming will be performed seamlessly.

Incidentally, an MEC architecture provided with conventional standard interfaces, protocols, and the like does not support such a use case, and thus the seamless streaming is not achieved. That is, there is no MEC architecture that can be implemented on mobile network capture devices of different vendors or models, MEC architecture that supports such services in a cloud environment, or the like.

Therefore, as described below, in the present embodiment, the advance preparations and the like as described above are made, so that there are newly proposed a standard protocol (application programming interface: API) and a flow (sequence) that are used in an MEC architecture required to achieve the seamless streaming.

Here, contents of a known technology will be described.

First, it is a known technology that an application migrates on the ME-Hosts 31, for example, when the user terminal 14 is handed over between the ME-Hosts 31-1 and 31-2. Meanwhile, resource negotiation required to execute the application at a migration destination is not prescribed as a standard protocol.

In addition, the European Telecommunications Standards Institute (ETSI) also prescribes a framework for registering execution conditions (static memory, disk upper limit, and the like) of a general application in an ME-Platform. However, there is no known technology for confirming the feasibility of execution with the ME-Platform on the basis of requirements required to execute the application.

Note that a protocol for duplicating a DANE as described below and synchronizing the states is unknown. For example, the present disclosure proposes state synchronization between individual servers of different CDNs rather than CDN-level synchronization, that is, the present disclosure proposes DASH-aware local optimization.

Here, contents newly proposed in the present disclosure will be further described.

First, it is assumed that the Edge-DANE 41-1 connected to the DASH-Client 21 on the user terminal 13 is being executed on the ME-Host 31-1 in the vicinity of the user terminal 13. Then, a protocol is newly proposed in which the state of the Edge-DANE 41-1 is synchronized with the state of the Edge-DANE 41-2 on the ME-Host 31-2 or the Edge-DANE 41-3 on the ME-Host 31-3 bound to a transition destination base station where the inter-base station handover of the user terminal 13 is predicted.

Therefore, in the present embodiment, as described below, resources are reserved for securing a CPU, storage area, input/output (IO) throughput, and the like for the Edge-DANE 41-2 or 41-3 to run on the ME-Host 31-2 or 31-3 in a transition destination cell. Then, the cache state of the Edge-DANE 41-1 before the transition is duplicated in advance. That is, the cache state optimized for the DASH-Client 21 on the Edge-DANE 41-1 before the transition is duplicated in the predicted transition destination cell. At this time, the state synchronization is continued until the transition is completed.

In addition, the cache state is changed in advance on the basis of a traffic prediction. That is, in a case where the traffic state of the transition destination cell is different and the stream quality after the transition may be changed, the optimum cache state in anticipation of the changed quality is configured in advance in the Edge-DANE 41-2 or 41-3 after the transition. Note that, in a case where a cache capacity cannot be sufficiently secured, the optimization is performed within the limit of the cache capacity. Alternatively, the Edge-DANE 41-1 as a transition source is maintained, and a request is redirected from the ME-Host 31-2 or 31-3 after the transition to the Edge-DANE 41-1 as the transition source.

Furthermore, in a case where there are two transition destination cells at the same time, that is, if the coverage of the transition destination cells has a hierarchical relationship, or if the user terminal 13 is at a cell boundary, for example, the optimized Edge-DANE 41 as described above is executed on the ME-Host 31 in a cell with a better environment. Furthermore, in a case where the transition destination cell cannot be predicted, the optimized Edge-DANE 41 as described above is executed on the ME-Hosts 31 in a plurality of adjacent cells.

### Information Processing System in First Embodiment

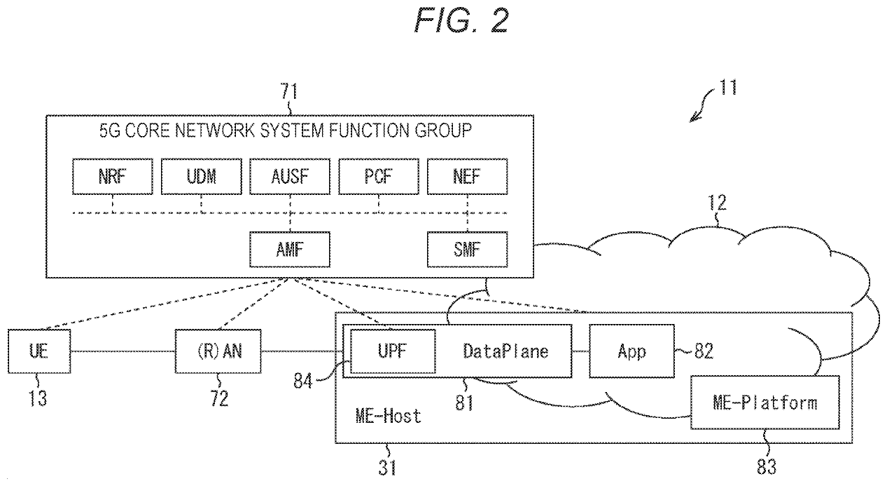

As the information processing system 11 in a first embodiment, pre-duplication of the cache state of the Edge-DANE 41-1 before the transition to the Edge-DANEs 41-2 and 41-3 as transition destinations will be described with reference to FIGS. 2 to 27. Note that the cache state of the Edge-DANE 41-1 may include a cache state in the near future corresponding to a request in the near future predicted from the present time.

For example, the information processing system 11 in the first embodiment is characterized in that, when the environment of the ME-Host 31 changes due to the inter-base station handover of the DASH-Client 21, resources are reserved for securing a CPU, storage area, IO throughput, and the like for the Edge-DANE 41 to run on the ME-Host 31 after the transition, and the cache state of the Edge-DANE 41 before the transition can be duplicated in advance.

FIG. 2 illustrates, as the information processing system 11 in the first embodiment, a 5G core network system function group 71 and a session between the user terminal 13 and an application 82 in the ME-Host 31, which is an MEC environment.

For example, in the information processing system 11, edge servers in edge computing can significantly improve a communication delay, which is one of bottlenecks of conventional cloud computing. Furthermore, distributed processing of a high-load application is executed among the user terminal 13, the ME-Host 31 as an edge server, and the ME-Host 32 as a cloud server, so that it is possible to speed up the processing.

Note that standard specifications for this edge computing are prescribed in the “ETSI-MEC”. Furthermore, an ME-Host in the ETSI-MEC corresponds to the ME-Host 31 as the edge server.

In the example illustrated in FIG. 2, a line connecting the application 82 on the ME-Host 31 and the user terminal 13 (application implemented thereon) via an access network 72 of the 5G core network 71 standardized by the Third Generation Partnership Project (3GPP) represents a user data session. Note that the access network ((R)AN) 72 in the 5G core network 71 includes a wired access network (access network: AN) and a wireless access network (radio access network: RAN).

In addition, on the ME-Host 31, there is an edge computing platform called a ME-Platform 83. Then, the application 82 executed on the ME-Platform 83 exchanges user data such as stream data with the user terminal 13 via a data plane 81, which is an abstraction of the user data session with the user terminal 13. Here, the data plane 81 has a function as a user plane function (UPF) 84 of the 3GPP. Note that the data plane 81 may have a function corresponding to the UPF 84.

In addition, the 5G (fifth generation mobile communication system) core network 71 adopts a service-based architecture, and a plurality of network functions (NFs) as functions of the core network is defined. Furthermore, these NFs are connected via a unified interface called a service-based interface.

In the example of FIG. 2, as the NFs, an NF repository function (NRF: service discovery for NFs), unified data management (UDM: management of subscriber information), an authentication server function (AUSF: management of authentication information of UEs), a policy control function (PCF: control of policies related to mobility and session management for proper operation of an AMF and an SMF), a network exposure function (NEF: provision of NF services to applications in an MNO network), the access and mobility management function (AMF: UE mobility management/authentication/authorization, and control of the SMF), and the session management function (SMF: UE session management) are shown.

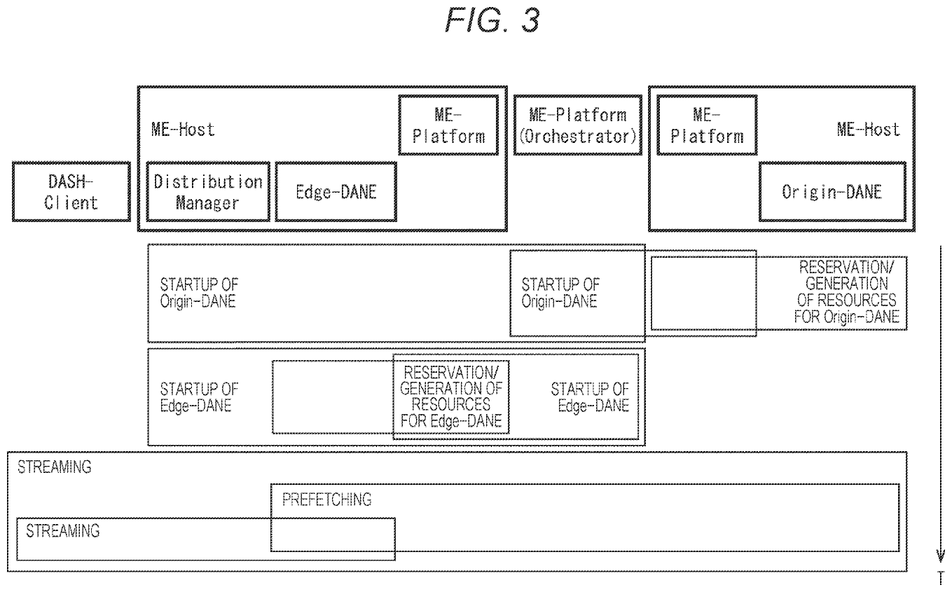

FIG. 3 is a diagram for describing processing in which the Origin-DANE application executed on the ME-Host 32 and the Edge-DANE application executed on the ME-Host 31 are started up by a DistributionManager implemented as an application on the ME-Host 31 in the information processing system 11 of FIG. 2.

First, Origin-DANE startup processing and Edge-DANE startup processing are performed.

The DistributionManager of the ME-Host 31 performs, via an API of the ME-Platform (Orchestrator) 33, the Origin-DANE startup processing on an ME-Platform on the ME-Host 32 that executes the Origin-DANE application to be started up. Similarly, the DistributionManager of the ME-Host 31 performs, via the API of the ME-Platform (Orchestrator) 33, the Edge-DANE startup processing on the ME-Platform on the ME-Host 31 itself.

At this time, the DistributionManager of the ME-Host 31 secures necessary resources and starts up the target application on the basis of a Workflow Description that describes network resources, calculation resources, storage resources, and the like required to execute the Origin-DANE application. As a result, the ME-Platform on the ME-Host 32 starts up the Origin-DANE 51, and the ME-Platform on the ME-Host 31 starts up the Edge-DANE 41.

After that, the DASH-Client 21 first finds the Edge-DANE 41-1 on the ME-Host 31-1 in the vicinity of the user terminal 13, and acquires DASH segments from the Origin-DANE 51 via the Edge-DANE 41-1. Note that, if the Edge-DANE 41 is not found, the DASH-Client 21 can acquire the DASH segments directly from the Origin-DANE 51.

Note that the Edge-DANE 41 can receive a SAND-AnticipatedRequest message, which is a SAND message transmitted from the DASH-Client 21 to the edge-DANE 41 and informing the Edge-DANE 41 of a set of DASH segments that may be acquired in the near future. Alternatively, the Edge-DANE 41 itself can voluntarily predict a request in the near future.

Then, the Edge-DANE 41 can read from the Origin-DANE 51 in advance a segment sequence of the DASH segments that may be requested from the DASH-Client 21 in the future (hereinafter referred to as prefetching). As a result, the Edge-DANE 41 can improve the performance of a response to the DASH-Client 21.

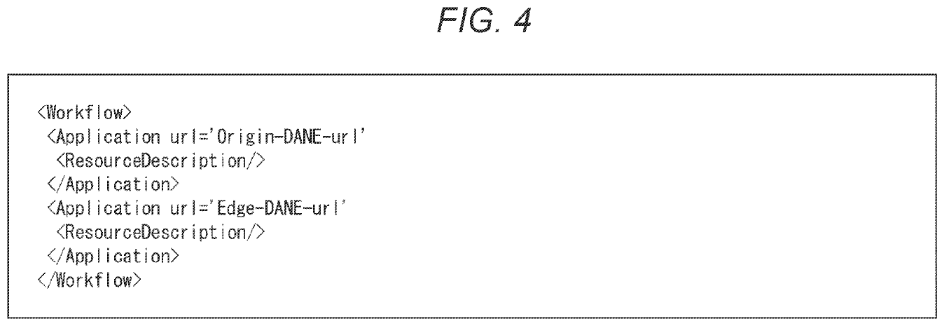

FIG. 4 illustrates an example of an independently-defined Workflow Description.

For example, a method of describing the Origin-DANE and the Edge-DANE in the Workflow Description is newly proposed in the present disclosure. Here, although the Workflow Description is defined independently, specifications of a workflow of media processing on the cloud and a framework of an application for the media processing are currently being formulated by MPEG-I-Network-Based Media Processing (NBMP), and the specifications have not been finalized. Note that, although the Origin-DANE and the Edge-DANE are described in this Workflow Description, there is no input/output connection between these DANEs in these Workflow Descriptions.

As illustrated in FIG. 4, a first element immediately below a Workfflow element is an Application element with a url attribute value ‘Origin-DANE-url’, which represents the execution of the Origin-DANE application. Next, there is an Application element with a url attribute value ‘Edge-DANE-url’, which represents the execution of the Edge-DANE application.

Stream files (DASH segment files) provided by the Origin-DANE 51 and the Edge-DANE 41 are accessed and acquired by another application by use of a file access method (HTTP) provided by a Web server that implements a system constituting the Origin-DANE 51 and the Edge-DANE 41. Furthermore, the stream files are first stored in the Origin-DANE 51, and then cached and copied in the Edge-DANE 41 on the basis of a request from the Edge-DANE 41.

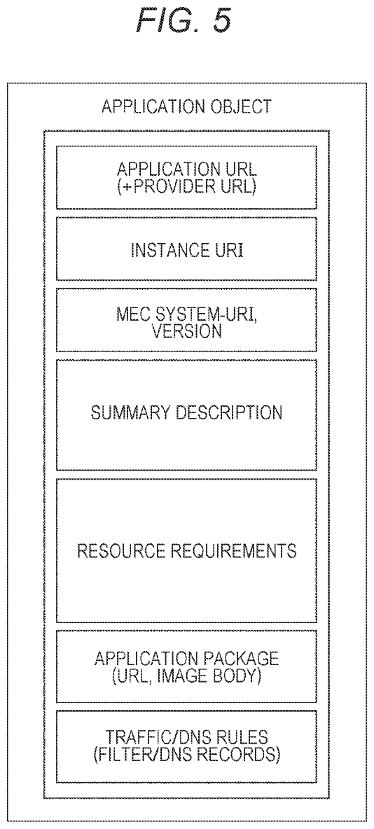

FIG. 5 illustrates an example of an application object that represents application attributes of the Origin-DANE application, the Edge-DANE application, and the like as described above. For example, it is assumed that attribute definitions of the application object are managed by an ME-Platform, and individual attributes of each application are managed on the basis of the attribute definitions.

An application URL (+provider URL) identifies the type of application such as Origin/Edge-DANE (a provider URL is also identified with a + option). For example, the type of application is specified by Application@url described in the workflow.

An instance URI identifies the application when the application is executed and is generated by the ME-Platform when the application is executed.

An MEC system-URI/version is an identifier that identifies an MEC system (virtual environment) in which the application is executed.

A summary description describes a summary of processing of the application.

Resource requirements include numerical specification or the like such as virtual CPU usage/second+period, virtual memory/storage capacity/second+period, and IO throughput/second+period, and are defined by MEC system URL-dependent resource class IDs. For example, the resource requirements are specified by a Resource Description described in the Workflow Description.

An application package (URL, image body) is a url or an image body of an MEC system-dependent application execution image.

Traffic/DNS rules (filter/DNS records) are information that controls routing of packets in a 5G system via the ME-Platform.

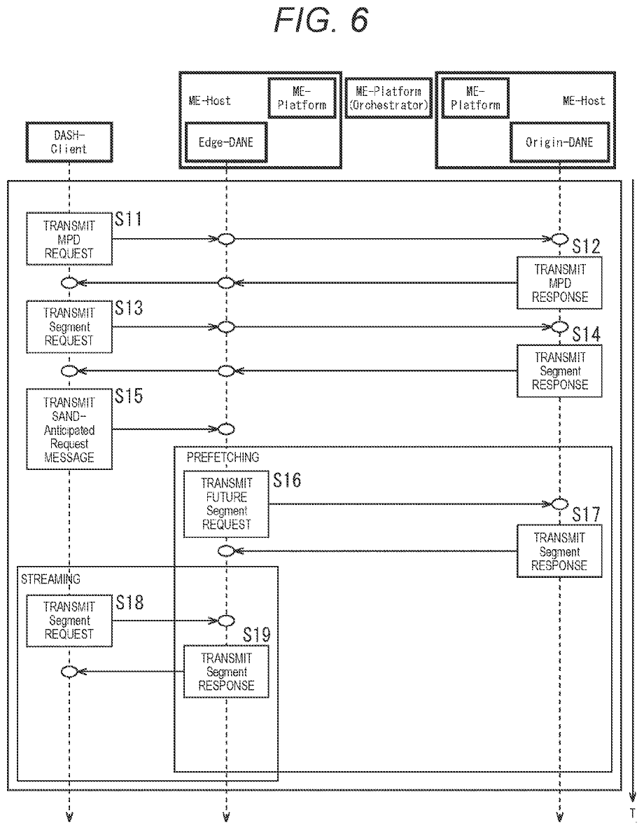

FIG. 6 is a flowchart for describing processing of starting the streaming in a case where the DASH-Client 21 notifies the Edge-DANE 41 of segments expected to be acquired in the future by a SAND message and the Edge-DANE 41 prefetches the segments.

In step S11, the DASH-Client 21 transmits a media presentation description (MPD) request to the Edge-DANE 41. Then, the Origin-DANE 51 receives the MPD request via the Edge-DANE 41 having received the MPD request. Note that an MPD is a file in which metadata of content to be streamed is described.

In step S12, the Origin-DANE 51 transmits an MPD response corresponding to the MPD request transmitted in step S11 to the Edge-DANE 41. Then, the DASH-Client 21 receives the MPD response via the Edge-DANE 41 having received the MPD response.

In step S13, the DASH-Client 21 transmits a segment request to the Edge-DANE 41 on the basis of the MPD response transmitted in step S12. Then, the Origin-DANE 51 receives the segment request via the Edge-DANE 41 having received the segment request.

In step S14, the Origin-DANE 51 transmits a segment response corresponding to the segment request transmitted in step S13 to the Edge-DANE 41. Then, the DASH-Client 21 receives the segment response via the segment response.

In step S15, the DASH-Client 21 predicts the DASH segments that may be acquired in the near future, and transmits, to the Edge-DANE 41, the SAND-AnticipatedRequest message informing the Edge-DANE 41 of the set of these DASH segments, and the Edge-DANE 41 receives the SAND-AnticipatedRequest message.

Then, in step S16 and a subsequent step, the prefetching is performed between the Edge-DANE 41 and the Origin-DANE 51. That is, in step S16, the Edge-DANE 41 transmits a future segment request to the Origin-DANE 51 on the basis of the SAND-AnticipatedRequest message received in step S15. In response to this, in step S17, the Origin-DANE 51 transmits a segment response. Then, similarly, the future segment request and the segment response are repeatedly transmitted and received.

Meanwhile, in step S18 and a subsequent step, the streaming is performed between the DASH-Client 21 and the Edge-DANE 41. That is, in step S18, the DASH-Client 21 transmits a segment request to the Edge-DANE 41. In response to this, in step S19, the Edge-DANE 41 transmits the already prefetched segment response to the DASH-Client 21. Then, similarly, the segment request and the segment response are repeatedly transmitted and received.

As described above, the Edge-DANE 41 prefetches the segments expected to be acquired in the future on the basis of the SAND-AnticipatedRequest message transmitted by the DASH-Client 21 to the Edge-DANE 41. As a result, the Edge-DANE 41 can improve the performance of the response to the DASH-Client 21.

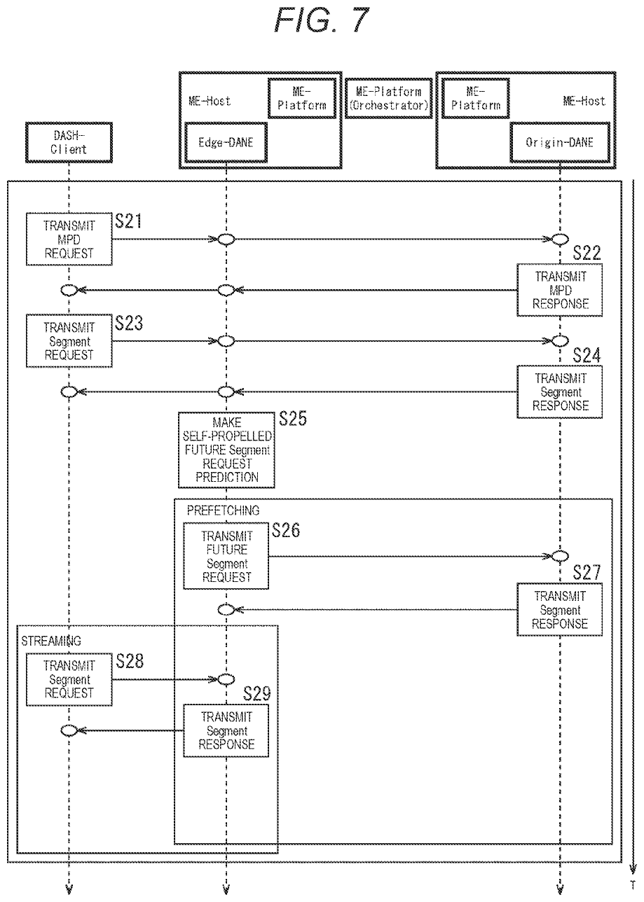

FIG. 7 is a flowchart for describing processing of starting the streaming in a case where the Edge-DANE 41 predicts the segments expected to be acquired in the future and voluntarily prefetches the segments.

For example, in steps S21 to S24, processing similar to that in steps S11 to S14 of FIG. 6 is performed. Then, in step S25, the Edge-DANE 41 voluntarily makes a self-propelled future segment request prediction to predict the DASH segments that may be requested in the near future.

Therefore, in step S26, the Edge-DANE 41 transmits a future segment request to the Origin-DANE 51 on the basis of the self-propelled future segment request prediction made in step S25. After that, in steps S27 to S29, processing similar to that in steps S17 to S19 of FIG. 6 is performed.

As described above, the Edge-DANE 41 predicts in advance the segments expected to be acquired in the future on the basis of a history of the latest segment request and segment response in the past transmitted to and received from the DASH-Client 21, for example, so that it is possible to prefetch the predicted segments. As a result, the Edge-DANE 41 can improve the performance of the response to the DASH-Client 21.

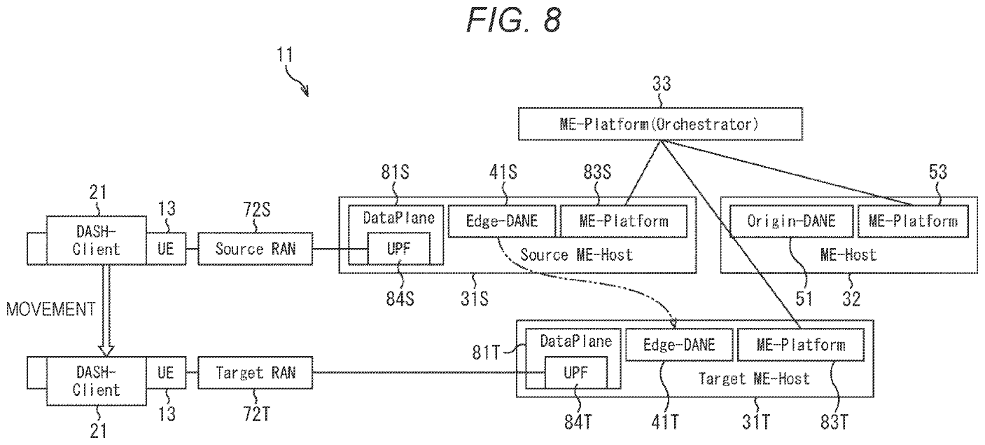

Next, the transition of the Edge-DANE 41 between the ME-Hosts 31 due to the inter-base station handover of the DASH-Client 21 will be described with reference to FIGS. 8 to 16.

For example, as illustrated in FIG. 8, when the user terminal 13 on which the DASH-Client 21 is implemented moves, the inter-base station handover occurs across base stations on which the ME-Hosts 31 are implemented. Hereinafter, the access network 72 before the handover will be referred to as a Source RAN 72S, and the ME-Host 31 before the handover will be referred to as a Source ME-Host 31S. Similarly, the access network 72 as a destination of the handover will be referred to as a Target RAN 72T, and the ME-Host 31 as a destination of the handover will be referred to as a Target ME-Host 31T.

Then, the user terminal 13 that implements the DASH-Client 21 streaming from the Edge-DANE application on the Source ME-Host 31S bound to the Source RAN 72S of a certain base station via the Source RAN 72S moves onto the Target ME-Host 31T of a base station to which the Target ME-Host 31T, which is different from the Source ME-Host 31S, is bound. Due to the inter-base station handover accompanying this movement, an Edge-DANE 41S on the Source ME-Host 31S transitions to an Edge-DANE 41T on the Source ME-Host 31T, as indicated by an arrow of a two-dot chain line in FIG. 8.

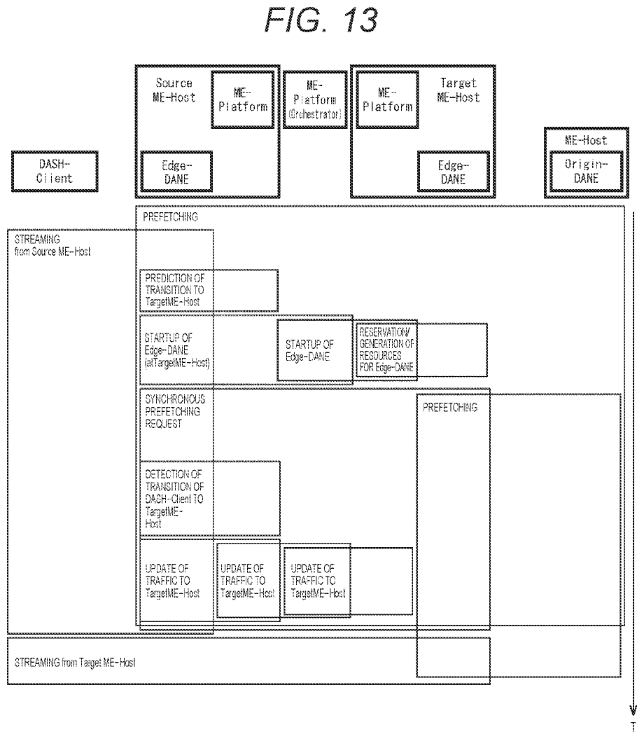

The processing performed at this time will be described with reference to a flow of FIG. 13. Note that the flow of FIG. 13 illustrates the processing after the streaming has already been started between the DASH-Client 21 and the Edge-DANE 41S.

That is, the DASH-Client 21 implemented on the user terminal 13 on the Source RAN 72S has already started the streaming on the basis of the stream files prefetched from the Origin-DANE 51 by the Edge-DANE 41S on the Source ME-Host 31S (streaming from Source ME-Host in FIG. 13). Note that the Origin-DANE 51 is executed on the ME-Host 32, which is different from the Edge-DANE 41S.

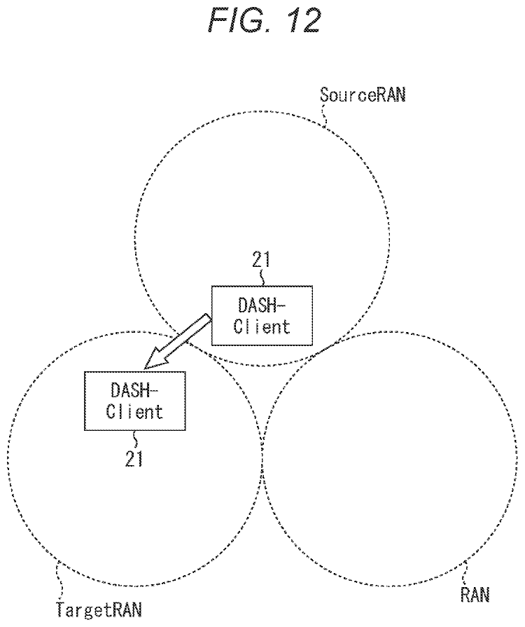

Here, as illustrated in FIG. 12, it is assumed that the user terminal 13 that implements the DASH-Client 21 moves onto the Target RAN 72T of the base station to which the Target ME-Host 31T, which is different from the Source ME-Host 31S, is bound. At this time, the Edge-DANE 41S (Edge-DANE application) executed on the Source ME-Host 31S transitions to the Target ME-Host 31T. Furthermore, an Edge-DANE application instance corresponding to the Edge-DANE application is separately generated on the Target ME-Host 31T as a transition destination, and at the same time, state information of the Edge-DANE application is duplicated in the Edge-DANE 41T.

In addition, the Edge-DANE 41S executed on the Source ME-Host 31S can detect, by an API provided by an ME-Platform 83S, the movement (position) of the user terminal 13 on which the DASH-Client 21 is implemented. Furthermore, it is assumed that it is predicted that the user terminal 13 moves from the Source RAN 72S, on which the user terminal 13 is currently located, to the Target RAN 72T, which is different from the Source RAN 72S, (prediction of transition to Target ME-Host in FIG. 13) from successive position transition information, statistical information, mobility pattern analysis using AI or the like, for example. Note that it is assumed that the Target ME-Host 31T is implemented on the base station of the Target RAN 72T as a transition destination.

Then, the Edge-DANE 41S on the Source ME-Host 31S requests the ME-Platform (Orchestrator) 33 to execute the Edge-DANE 41T on the Target ME-Host 31T (startup of Edge-DANE (at Target ME-Host) in FIG. 13).

In response to this, an ME-Platform 83T on the Target ME-Host 31T attempts to reserve and execute resources on the basis of protocol resource requirements equivalent to those of a session currently established between the DASH-Client 21 and the Edge-DANE 41S.

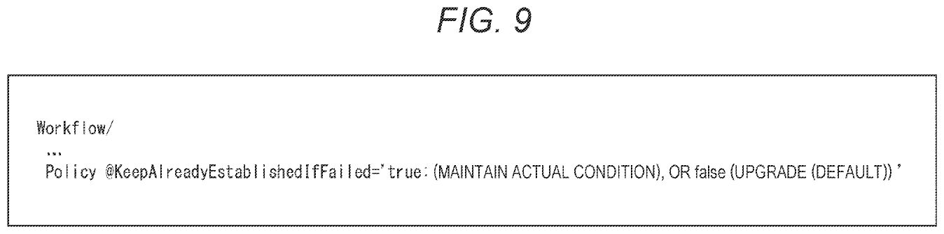

Here, it is assumed that policies such as maintaining the session currently established between the DASH-Client 21 and the Edge-DANE 41S, continuing the service with lower (or higher) quality than the currently established session in anticipation of the traffic of the transition destination cell and the load status of the ME-Platform 83T, and maintaining the session currently established between the DASH-Client 21 and the Edge-DANE 41S on the Source ME-Host 31S in a case where the quality has to be lowered are based on specification by a ‘session update policy at the time of handover’ described in the Workflow Description as illustrated in FIG. 9.

For example, in a case of KeepAlreadyEstablishedIfFailed=‘true’, it is specified that the session is maintained as it is at the time of handover. On the other hand, in a case of KeepAlreadyEstablishedIfFailed=‘false’, it is specified that the session is upgraded at the time of handover, which is the default.

In addition, the Edge-DANE 41T on the Target ME-Host 31T is started up with the required resources reserved (reservation/generation of resources for Edge-DANE in FIG. 13), but streaming processing for the DASH-Client 21 does not start immediately. For example, the Edge-DANE 41S on the Source ME-Host 31S makes a synchronous prefetching request to request synchronized pre-reading, and the Edge-DANE 41T receives the synchronous prefetching request (synchronous prefetching request in FIG. 13). Note that a messaging protocol for the synchronous prefetching request used in the synchronous prefetching request will be described later.

As a result, the Edge-DANE 41T can prefetch the stream files from the Origin-DANE 51 while synchronizing with the Edge-DANE 41S on the Source ME-Host 31S.

It is assumed that, after a further period of time, the Edge-DANE 41S on the Source ME-Host 31S detects, via the ME-Platform 83S, the movement of the user terminal 13 on which the DASH-Client 21 is implemented and a new connection to the Target RAN 72T to which the Target ME-Host 31T is bound (detection of transition of DASH-Client to Target ME-Host in FIG. 13).

In response to this, the traffic is changed so that the streaming request from the Target RAN 72T after the transition can be received by the Edge-DANE 41T on the Target ME-Host 31T (update of traffic to Target ME-Host in FIG. 13). At the same time, the traffic is changed so that the response from the Edge-DANE 41T on the Target ME-Host 31T reaches the user terminal 13.

After that, the Edge-DANE 41T on the Target ME-Host 31T starts, via the Target RAN 72T, the streaming to the DASH-Client 21 after the movement (streaming from Target ME-Host in FIG. 13).

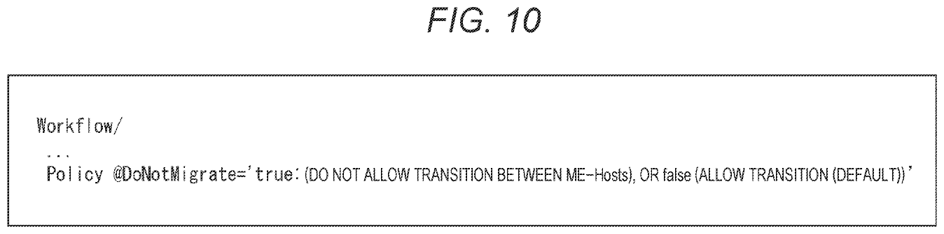

Note that, as illustrated in FIG. 10, in the Workflow Description, it is possible to specify whether or not to allow the transition itself of the Edge-DANE application between the ME-Hosts 31. For example, in a case where the transition itself of the Edge-DANE application between the ME-Hosts 31 is not allowed, Policy@DoNotMigrate=‘true’ is specified. On the other hand, in a case of attempting the transition between the ME-Hosts 31, Policy@DoNotMigrate=‘false’ is specified, which is the default because of taking advantage of MEC as much as possible. Needless to say, in the case of Policy@DoNotMigrate=‘true’, KeepAlreadyEstablishedIfFailed illustrated in FIG. 9 cannot be specified.

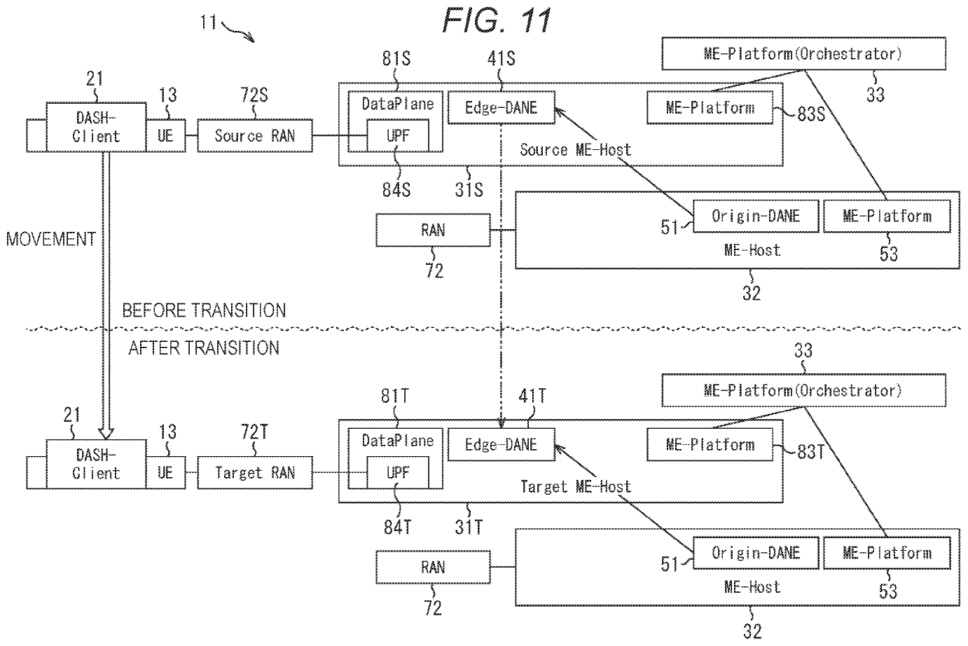

Furthermore, FIG. 11 illustrates states before and after the transition in which the Edge-DANE 41 transitions by the above-described processing, which accompanies the occurrence of the inter-base station handover due to the movement of the DASH-Client 21.

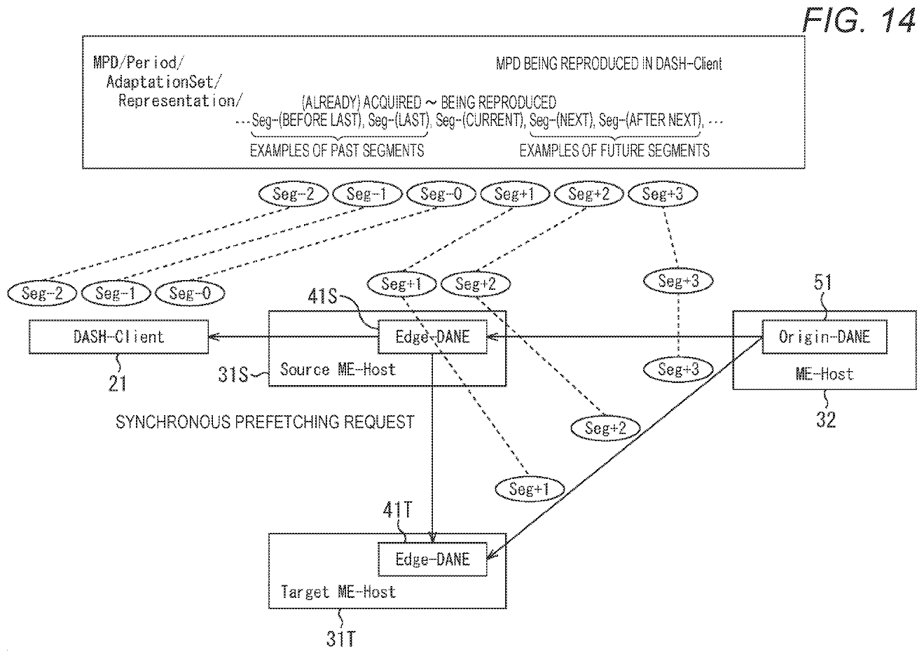

FIG. 14 illustrates a segment flow when the synchronous prefetching request of FIG. 13 serves as a trigger to start the prefetching.

For example, as illustrated, in the DASH-Client 21, past segments (Seg−1, Seg−2, Seg−3, . . . ) are streamed via the Edge-DANE 41S and have already been reproduced. Then, it is assumed that the synchronous prefetching request is made at the timing when a segment (Seg−0) currently being reproduced is being streamed in the DASH-Client 21.

At this time, the synchronous prefetching request serves as a trigger to start to prefetch segments (Seg+1, Seg+2, Seg+3, . . . ) of the same AdaptationSet, which will be required later than the current segment Seg−0. That is, as illustrated, the future segments (Seg+1, Seg+2, Seg+3, . . . ) start to be transmitted to the Edge-DANE 41T in synchronization with transmission from the Origin-DANE 51 to the Edge-DANE 41S.

Note that this prefetching is started when it is confirmed that session resources equivalent to current session resources via the Source ME-Host 31S are secured even in the environment via the Target ME-Host 31T. In addition, it is assumed that system clock synchronization is performed between the Source ME-Host 31S and the Target ME-Host 31T by a network time protocol (NTP) or the like, and the same Wallclock is shared.

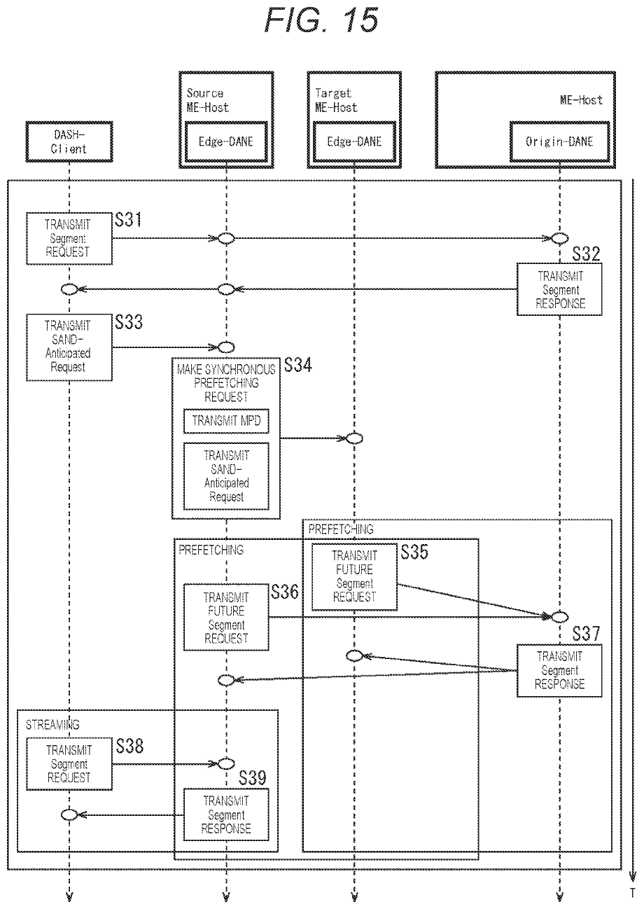

FIG. 15 is a flowchart for describing processing of starting the streaming in a case where the DASH-Client 21 notifies the Edge-DANE 41S of the segments expected to be acquired in the future by the SAND message and the Edge-DANE 41S and the Edge-DANE 41T prefetch the segments.

In step S31, the DASH-Client 21 transmits a segment request to the Edge-DANE 41S. Then, the Origin-DANE 51 receives the segment request via the Edge-DANE 41S having received the segment request.

In step S32, the Origin-DANE 51 transmits a segment response corresponding to the segment request transmitted in step S31 to the Edge-DANE 41S. Then, the DASH-Client 21 receives the segment response via the Edge-DANE 41S having received the segment response.

In step S33, the DASH-Client 21 predicts the DASH segments that may be acquired in the near future, and transmits, to the Edge-DANE 41S, the SAND-AnticipatedRequest message informing the Edge-DANE 41S of the set of these DASH segments, and the Edge-DANE 41S receives the SAND-AnticipatedRequest message.

In step S34, the Edge-DANE 41S transmits the MPD and the SAND-AnticipatedRequest message to the Edge-DANE 41T to make the synchronous prefetching request.

Then, the prefetching between the Edge-DANE 41T and the Origin-DANE 51 in step S35 and a subsequent step and the prefetching between the Edge-DANE 41S and the Origin-DANE 51 in step S36 and a subsequent step are performed synchronously. That is, in step S35, the Edge-DANE 41T transmits a future segment request to the Origin-DANE 51, and in step S36, the Edge-DANE 41S transmits a future segment request to the Origin-DANE 51. In response to this, in step S37, the Origin-DANE 51 transmits a segment response. Then, similarly, the future segment request and the segment response are repeatedly transmitted and received.

Meanwhile, in step S38 and a subsequent step, the streaming is performed between the DASH-Client 21 and the Edge-DANE 41S. That is, in step S38, the DASH-Client 21 transmits a segment request to the Edge-DANE 41S. In response to this, in step S39, the Edge-DANE 41S transmits the already prefetched segment response to the DASH-Client 21. Then, similarly, the segment request and the segment response are repeatedly transmitted and received.

As described above, the Edge-DANE 41S and the Edge-DANE 41T can perform the prefetching synchronously. As a result, the Edge-DANE 41T can improve the performance of the response to the DASH-Client 21 at the time of transition to the streaming from the Edge-DANE 41T, which accompanies the subsequent movement of the DASH-Client 21.

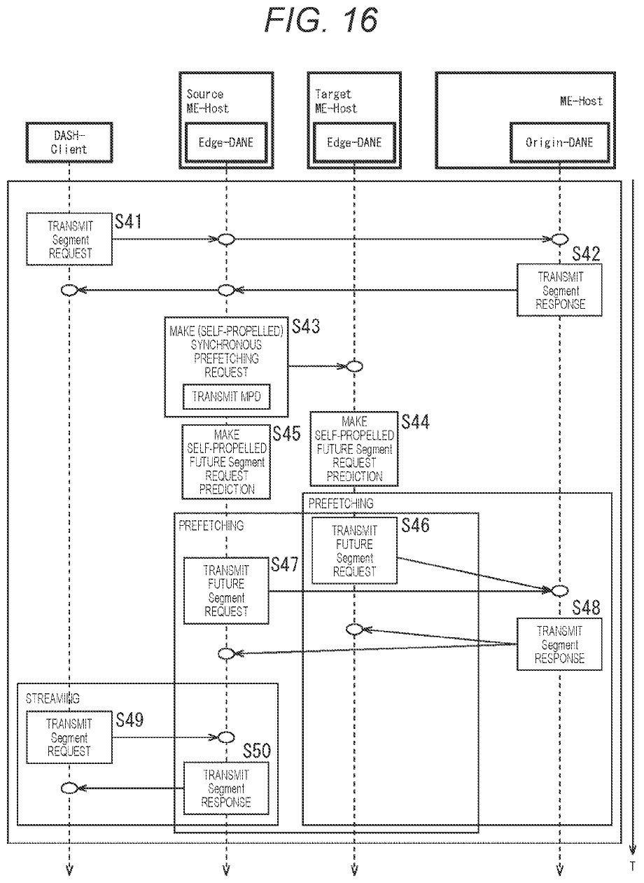

FIG. 16 is a flowchart for describing processing of starting the streaming in a case where the Edge-DANE 41S and the Edge-DANE 41T predict the segments expected to be acquired in the future and voluntarily prefetch the segments.

For example, in steps S41 and S42, processing similar to that in steps S31 and S32 of FIG. 15 is performed. Then, in step S43, the Edge-DANE 41S transmits the MPD to the Edge-DANE 41T and makes the (self-propelled) synchronous prefetching request to synchronize the prefetching with the Edge-DANE 41T.

In response to this, in step S44, the Edge-DANE 41T refers to the MPD and voluntarily makes the self-propelled future segment request prediction to predict the DASH segments that may be requested in the near future. Similarly, in step S45, the Edge-DANE 41S refers to the MPD and voluntarily makes the self-propelled future segment request prediction to predict the DASH segments that may be requested in the near future. After that, in steps S46 to S50, processing similar to that in steps S35 to S39 of FIG. 15 is performed.

As described above, each of the Edge-DANE 41S and the Edge-DANE 41T can predict in advance the segments expected to be acquired in the future, and prefetch the predicted segments synchronously. As a result, the Edge-DANE 41T can improve the performance of the response to the DASH-Client 21 at the time of transition to the streaming from the Edge-DANE 41T, which accompanies the subsequent movement of the DASH-Client 21.

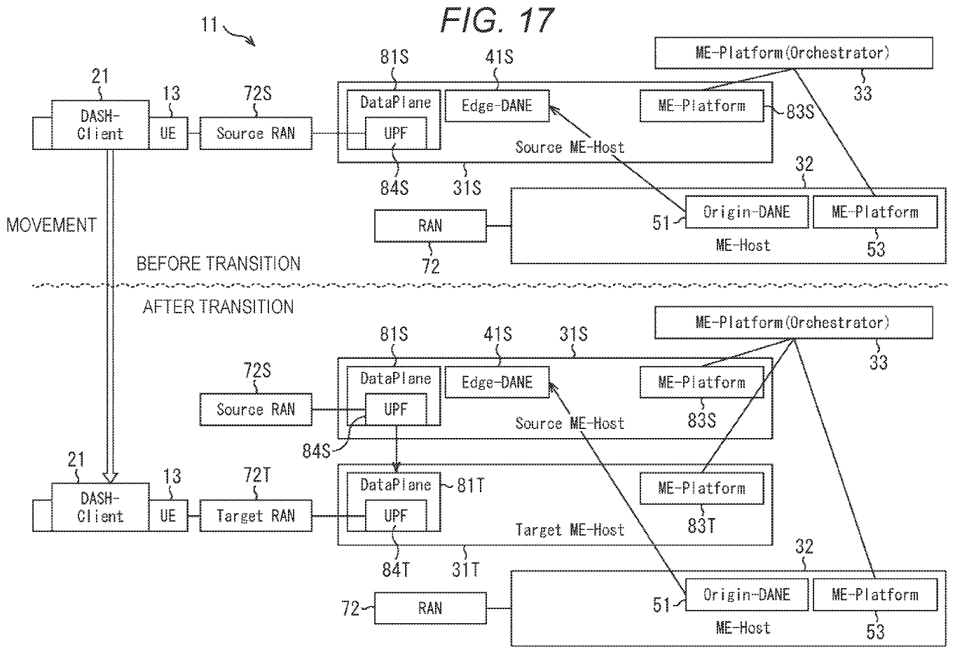

Next, processing in a case where the Edge-DANE 41 cannot be started up on the ME-Host 31 as a transition destination due to lack of resources will be described with reference to FIGS. 17 to 19.

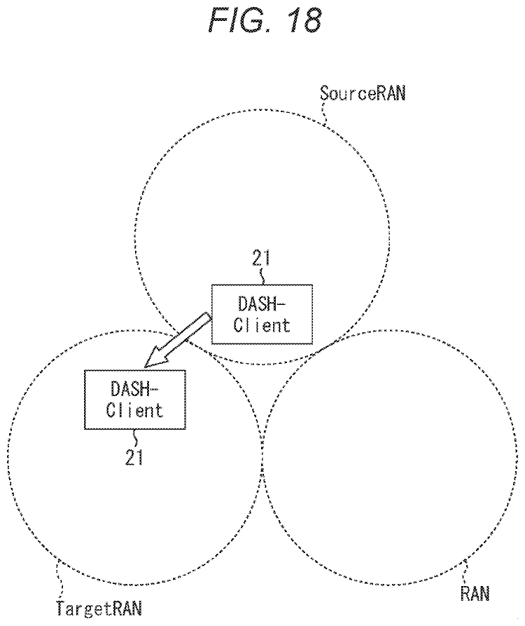

FIG. 17 illustrates states before and after the transition accompanying the occurrence of the inter-base station handover due to the movement of the DASH-Client 21 from the Source RAN 72S to the Target RAN 72T (see FIG. 18).

That is, the user terminal 13 that implements the DASH-Client 21 streaming from the Edge-DANE application on the Source ME-Host 31S bound to the Source RAN 72S of a certain base station via the Source RAN 72S moves onto the Target ME-Host 31T of a base station to which the Target ME-Host 31T, which is different from the Source ME-Host 31S, is bound. Due to the inter-base station handover accompanying this movement, the transition of the Edge-DANE 41S on the Source ME-Host 31S is attempted, but there is a case where the Edge-DANE 41T on the Source ME-Host 31T cannot be started up due to the lack of resources.

In this case, while the Edge-DANE 41S on the Source ME-Host 31S is maintained, the segments received by the Edge-DANE 41S from the Origin-DANE 51 can be transmitted from a data plane 81S to a data plane 81T, and then transmitted to the DASH-Client 21 via the Target RAN 72T.

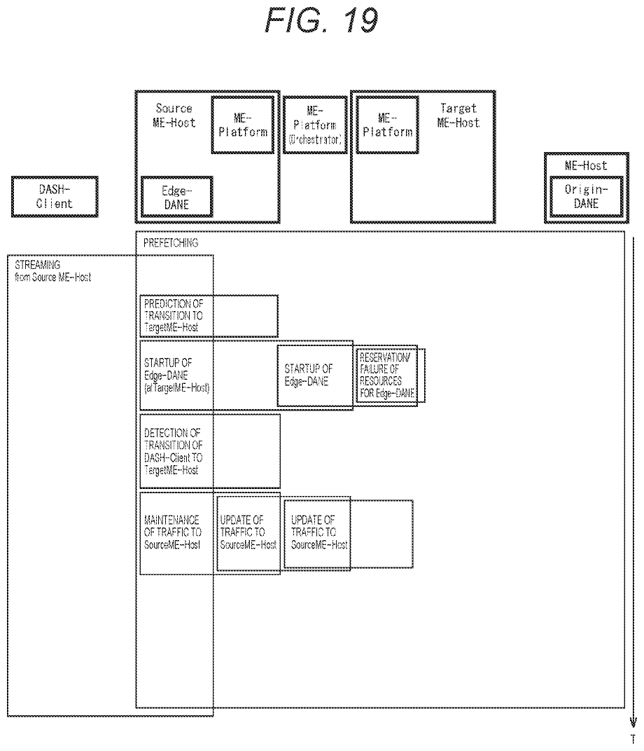

The processing performed at this time will be described with reference to a flow of FIG. 19. Note that the flow of FIG. 19 illustrates the processing after the streaming has already been started between the DASH-Client 21 and the Edge-DANE 41S.

First, as described above with reference to the flow of FIG. 13, the Edge-DANE 41S predicts that the user terminal 13 will move from the Source RAN 72S, on which the user terminal 13 is currently located, to the Target RAN 72T, which is different from the Source RAN 72S (prediction of transition to Target ME-Host in FIG. 19).

Then, the Edge-DANE 41S on the Source ME-Host 31S requests the ME-Platform (Orchestrator) 33 to execute the Edge-DANE 41T on the Target ME-Host 31T (startup of Edge-DANE (at Target ME-Host) in FIG. 19).

In response to this, the ME-Platform 83T on the Target ME-Host 31T attempts to reserve and execute resources on the basis of protocol resource requirements equivalent to those of the session currently established between the DASH-Client 21 and the Edge-DANE 41S. However, in this case, the Edge-DANE 41T fails to be started up.

It is assumed that, after a further period of time, the Edge-DANE 41S on the Source ME-Host 31S detects, via the ME-Platform 83S, the movement of the user terminal 13 on which the DASH-Client 21 is implemented and the new connection to the Target RAN 72T to which the Target ME-Host 31T is bound (detection of transition of DASH-Client to Target ME-Host in FIG. 19).

In this case, the Edge-DANE 41S maintains the traffic so that the streaming request from the Target RAN 72T after the transition can be received by the Edge-DANE 41S on the Source ME-Host 31S (maintenance of traffic to Source ME-Host in FIG. 19). At the same time, the traffic is changed to the Source ME-Host 31S for the ME-Platform 83T on the Target ME-Host 31T.

As a result, even in a case where the Edge-DANE 41T fails to be started up on the Target ME-Host 31T, the streaming to the DASH-Client 21 can be achieved via the Target RAN 72T while the Edge-DANE 41S on the Source ME-Host 31S is maintained.

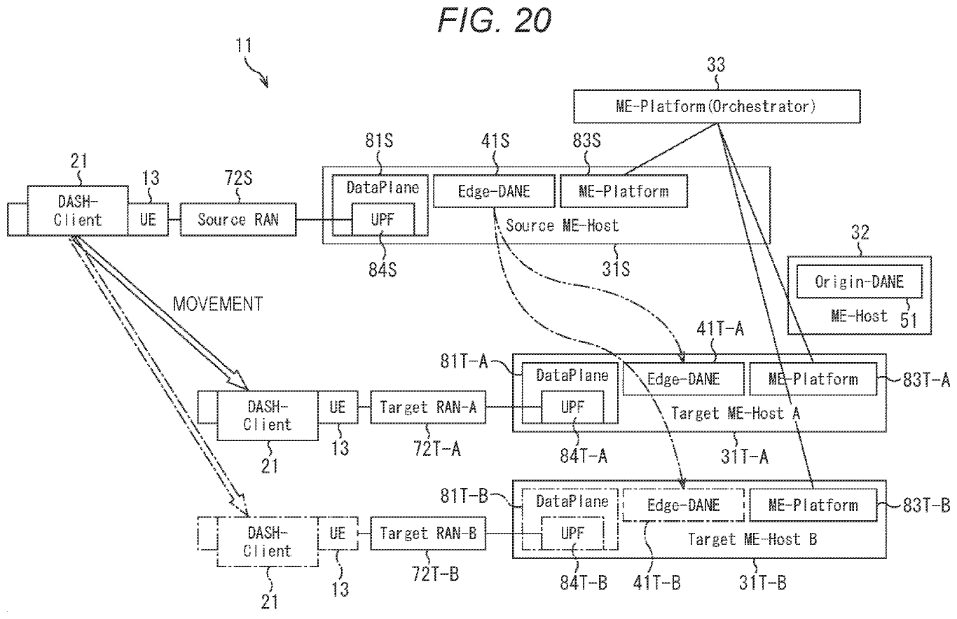

Processing of executing the Edge-DANE 41T on each of a Target ME-Host 31T-A and a Target ME-Host 31T-B bound to two cells (Target RAN 72T-A and Target RAN 72T-B) to which the DASH-Client 21 is expected to transition in a case where the transition destination cell (RAN 72) cannot be predicted will be described with reference to FIGS. 20 to 23. Here, a case where the DASH-Client 21 finally transitions to the Target RAN 72T-A bound to the Target ME-Host 31T-A is shown.

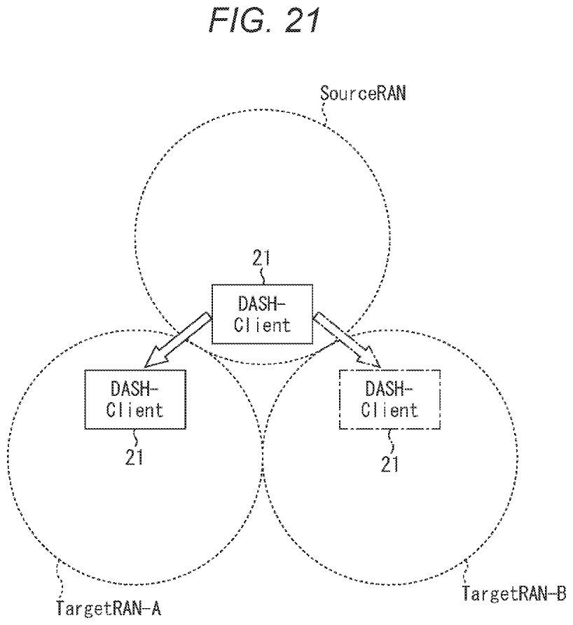

For example, FIG. 20 illustrates a state accompanying the occurrence of the inter-base station handover due to the movement of the DASH-Client 21 from the Source RAN 72S to the Target RAN 72T-A (see FIG. 21).

That is, in a case where it is not possible to predict to which of the Target RAN 72T-A and the Target RAN 72T-B the DASH-Client 21 will transition, an Edge-DANE 41T-A is started up on the Target ME-Host 31T-A and an Edge-DANE 41T-B is started up on the Target ME-Host 31T-B. Furthermore, when the transition of the DASH-Client 21 to the Target RAN 72T-A is detected, the streaming to the DASH-Client 21 is performed from the Edge-DANE 41T-A via the Target RAN 72T-A.

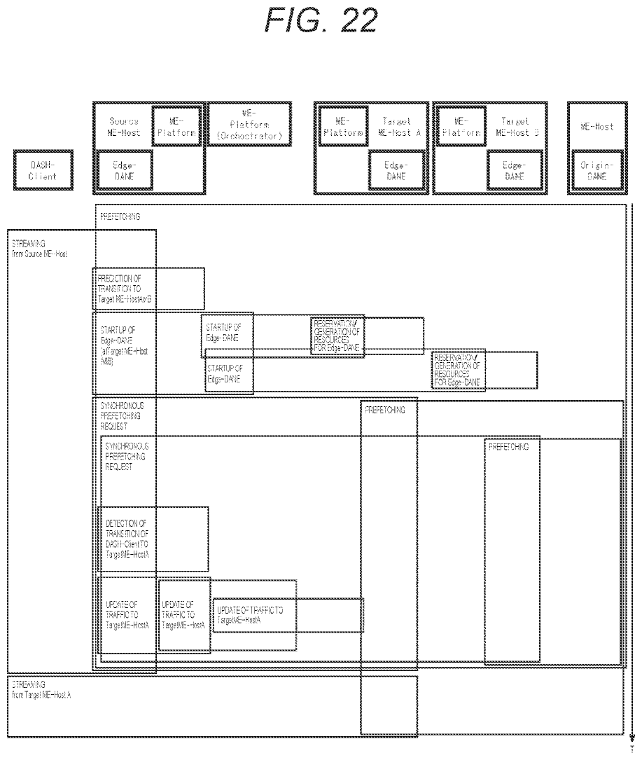

The processing performed at this time will be described with reference to a flow of FIG. 22. Note that the flow of FIG. 22 illustrates the processing after the streaming has already been started between the DASH-Client 21 and the Edge-DANE 41S.

First, as described above with reference to the flow of FIG. 13, the Edge-DANE 41S predicts that the user terminal 13 will move from the Source RAN 72S, on which the user terminal 13 is currently located, to the Target RAN 72T-A or the Target RAN 72T-B, which is different from the Source RAN 72S (prediction of transition to Target ME-Host A or B in FIG. 22). That is, in this case, it is not possible to predict to which of the Target RAN 72T-A and the Target RAN 72T-B the user terminal 13 will move.

Then, the Edge-DANE 41S on the Source ME-Host 31S requests the ME-Platform (Orchestrator) 33 to execute the Edge-DANE 41T-A on the Target ME-Host 31T-A and execute the Edge-DANE 41T-B on the Target ME-Host 31T-B (startup of Edge-DANE (at Target ME-Host A & B) in FIG. 22).

In response to this, the ME-Platform 83T on the Target ME-Host 31T attempts to reserve and execute resources on the basis of protocol resource requirements equivalent to those of the session currently established between the DASH-Client 21 and the Edge-DANE 41S. As a result, the Edge-DANE 41T-A on the Target ME-Host 31T-A is started up with the required resources reserved (reservation/generation of resources for Edge-DANE in FIG. 22). Similarly, the Edge-DANE 41T-B on the Target ME-Host 31T-B is started up with the required resources reserved (reservation/generation of resources for Edge-DANE in FIG. 22).

After that, the ME-Platform 83T on the Target ME-Host 31T makes the synchronous prefetching request to the Edge-DANE 41T-A on the Target ME-Host 31T-A, and also makes the synchronous prefetching request to the Edge-DANE 41T-B on the Target ME-Host 31T-B. As a result, the Edge-DANE 41T-A and the Edge-DANE 41T-B can prefetch the stream files from the Origin-DANE 51 while synchronizing with the Edge-DANE 41S on the Source ME-Host 31S.

It is assumed that, after a further period of time, the Edge-DANE 41S on the Source ME-Host 31S detects, via the ME-Platform 83S, the movement of the user terminal 13 on which the DASH-Client 21 is implemented and a new connection to the Target RAN 72T-A to which the Target ME-Host 31T-A is bound (detection of transition of DASH-Client to Target ME-Host A in FIG. 22).

In response to this, the traffic is changed so that the streaming request from the Target RAN 72T-A after the transition can be received by the Edge-DANE 41T-A on the Target ME-Host 31T-A (update of traffic to Target ME-Host A in FIG. 22). At the same time, the traffic is changed so that a response from the Edge-DANE 41T-A on the Target ME-Host 31T-A reaches the user terminal 13.

After that, the Edge-DANE 41T-A on the Target ME-Host 31T-A starts, via the Target RAN 72T-A, the streaming to the DASH-Client 21 after the movement (streaming from Target ME-Host A in FIG. 22). At this time, the prefetching of the Edge-DANE 41T-A on the Target ME-Host 31T-A is continued, while the prefetching of the Edge-DANE 41T-B on the Target ME-Host 31T-B is terminated.

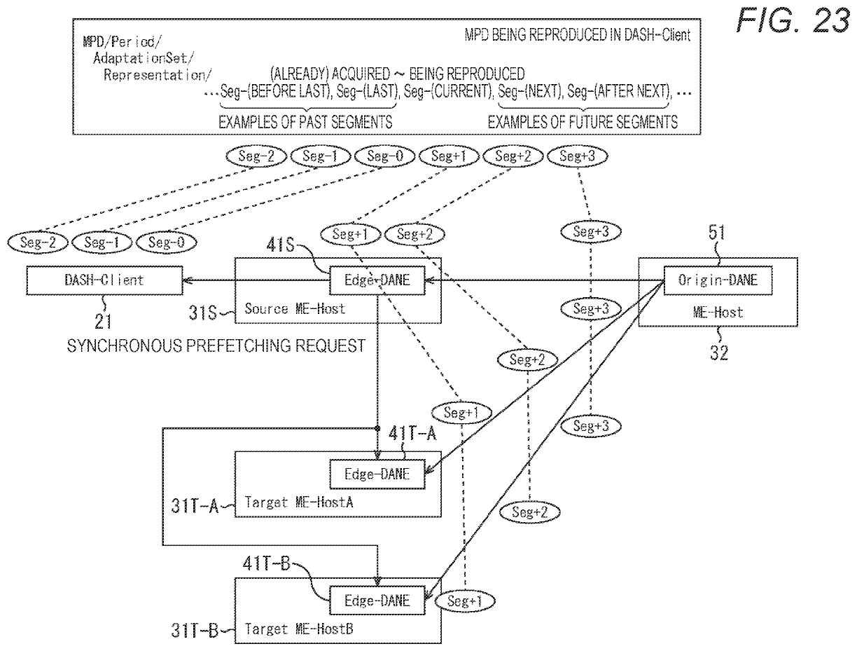

FIG. 23 illustrates a segment flow when the synchronous prefetching request of FIG. 22 serves as a trigger to start the prefetching.

For example, as illustrated, in the DASH-Client 21, the past segments (Seg−1, Seg−2, Seg−3, . . . ) are streamed via the Edge-DANE 41S and have already been reproduced. Then, it is assumed that the synchronous prefetching request is made at the timing when the segment (Seg−0) currently being reproduced is being streamed in the DASH-Client 21.

At this time, the synchronous prefetching request serves as a trigger to start to prefetch the segments (Seg+1, Seg+2, Seg+3, . . . ) of the same AdaptationSet that will be required later than the current segment Seg−0. That is, as illustrated in the drawing, the future segments (Seg+1, Seg+2, Seg+3, . . . ) start to be transmitted to both the Edge-DANE 41T-A and the Edge-DANE 41T-B in synchronization with transmission from the Origin-DANE 51 to the Edge-DANE 41S.

Note that this prefetching is started when it is confirmed that session resources equivalent to the current session resources via the Source ME-Host 31S are secured even in the environment via the Target ME-Host 31T-A and the Target ME-Host 31T-B. In addition, it is assumed that the system clock synchronization is performed between the Source ME-Host 31S and each of the Target ME-Host 31T-A and the Target ME-Host 31T-B by the Network Time Protocol (NTP) or the like, and the same Wallclock is shared.

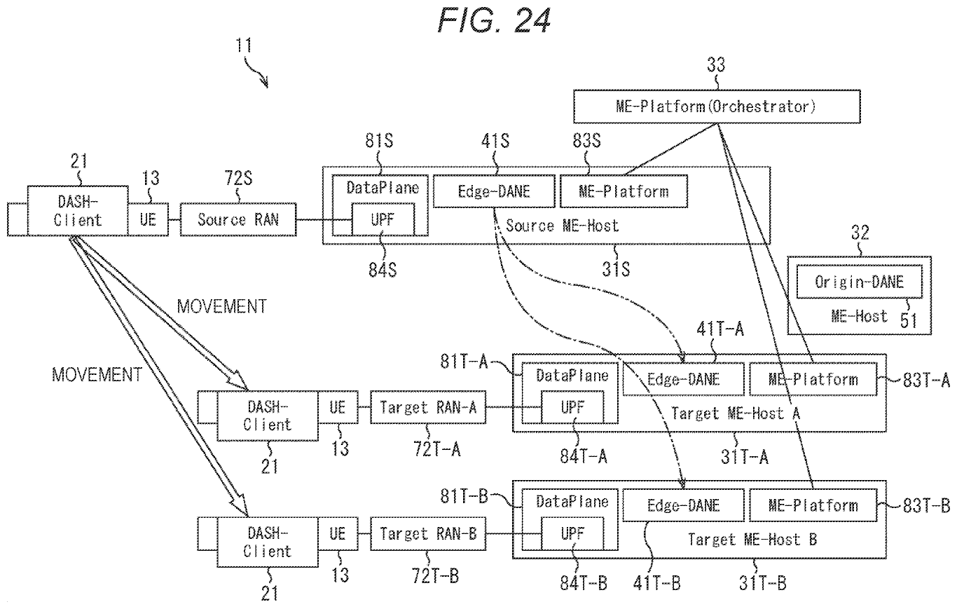

Processing of ensuring fault tolerance redundancy will be described with reference to FIGS. 24 to 27. Here, an example is shown where the Edge-DANE 41T is executed on each of the Target ME-Host 31T-A and the Target ME-Host 31T-B bound to two cells with overlapping coverage (Target RAN 72T-A and Target RAN 72T-B), and two streaming sessions are executed synchronously. Note that it is assumed that the DASH-Client 21 after the transition is connected to both the Target RAN 72T-A and the Target RAN 72T-B at the same time.

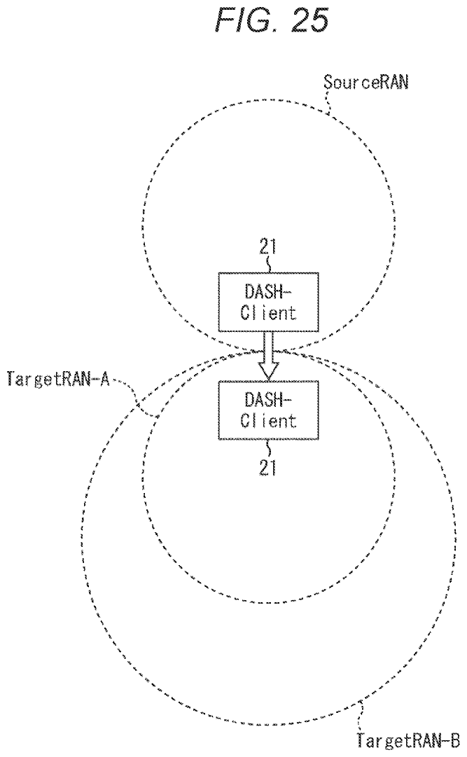

For example, FIG. 24 illustrates a state accompanying the occurrence of the inter-base station handover due to the movement of the DASH-Client 21 from the Source RAN 72S to the Target RAN 72T-A and the Target RAN 72T-B (see FIG. 25).

That is, in a case where the coverage of the Target RAN 72T-A and the coverage of the Target RAN 72T-B overlap, the Edge-DANE 41T-A is started up on the Target ME-Host 31T-A and the Edge-DANE 41T-B is started up on the Target ME-Host 31T-B. Furthermore, when the transition of the DASH-Client 21 to the Target RAN 72T-A and the Target RAN 72T-B is detected, the streaming to the DASH-Client 21 is performed from the Edge-DANE 41T-A and the Edge-DANE 41T-B via the Target RAN 72T-A and the Target RAN 72T-B, respectively.

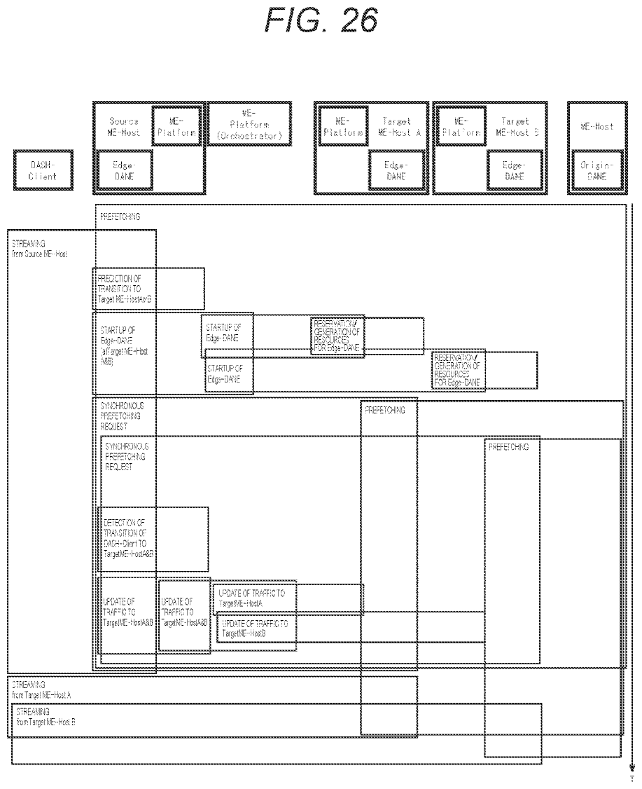

The processing performed at this time will be described with reference to a flow of FIG. 26. Note that the flow of FIG. 26 illustrates the processing after the streaming has already been started between the DASH-Client 21 and the Edge-DANE 41S.

First, as described above with reference to the flow of FIG. 13, the Edge-DANE 41S predicts that the user terminal 13 will move from the Source RAN 72S, on which the user terminal 13 is currently located, to the Target RAN 72T-A or the Target RAN 72T-B, which is different from the Source RAN 72S (prediction of transition to Target ME-Host A or B in FIG. 26).

Then, the Edge-DANE 41S on the Source ME-Host 31S requests the ME-Platform (Orchestrator) 33 to execute the Edge-DANE 41T-A on the Target ME-Host 31T-A and execute the Edge-DANE 41T-B on the Target ME-Host 31T-B (startup of Edge-DANE (at Target ME-Host A & B) in FIG. 26).

In response to this, the ME-Platform 83T on the Target ME-Host 31T attempts to reserve and execute resources on the basis of protocol resource requirements equivalent to those of the session currently established between the DASH-Client 21 and the Edge-DANE 41S. As a result, the Edge-DANE 41T-A on the Target ME-Host 31T-A is started up with the required resources reserved (reservation/generation of resources for Edge-DANE in FIG. 26). Similarly, the Edge-DANE 41T-B on the Target ME-Host 31T-B is started up with the required resources reserved (reservation/generation of resources for Edge-DANE in FIG. 26).

After that, the ME-Platform 83T on the Target ME-Host 31T makes the synchronous prefetching request to the Edge-DANE 41T-A on the Target ME-Host 31T-A, and also makes the synchronous prefetching request to the Edge-DANE 41T-B on the Target ME-Host 31T-B. As a result, the Edge-DANE 41T-A and the Edge-DANE 41T-B can prefetch the stream files from the Origin-DANE 51 while synchronizing with the Edge-DANE 41S on the Source ME-Host 31S.

It is assumed that, after a further period of time, the Edge-DANE 41S on the Source ME-Host 31S detects, via the ME-Platform 83S, the movement of the user terminal 13 on which the DASH-Client 21 is implemented and new connections to the Target RAN 72T-A to which the Target ME-Host 31T-A is bound and the Target RAN 72T-B to which the Target ME-Host 31T-B is bound (detection of transition of DASH-Client to Target ME-Host A & B in FIG. 26).

In response to this, the traffic is changed so that the streaming request from the Target RAN 72T-A after the transition can be received by the Edge-DANE 41T-A on the Target ME-Host 31T-A (update of traffic to Target ME-Host A in FIG. 26). At the same time, the traffic is changed so that the response from the Edge-DANE 41T-A on the Target ME-Host 31T-A reaches the user terminal 13.

Similarly, the traffic is changed so that the streaming request from the Target RAN 72T-B after the transition can be received by the Edge-DANE 41T-B on the Target ME-Host 31T-B (update of traffic to Target ME-Host B in FIG. 26). At the same time, the traffic is changed so that a response from the Edge-DANE 41T-B on the Target ME-Host 31T-B reaches the user terminal 13.

After that, the Edge-DANE 41T-A on the Target ME-Host 31T-A starts, via the Target RAN 72T-A, the streaming to the DASH-Client 21 after the movement (streaming from Target ME-Host A in FIG. 26). In addition, the prefetching of the Edge-DANE 41T-A on the Target ME-Host 31T-A is continued.

Similarly, the Edge-DANE 41T-B on the Target ME-Host 31T-B starts, via the Target RAN 72T-B, the streaming to the DASH-Client 21 after the movement (streaming from Target ME-Host B in FIG. 26). In addition, the prefetching of the Edge-DANE 41T-B on the Target ME-Host 31T-B is continued.

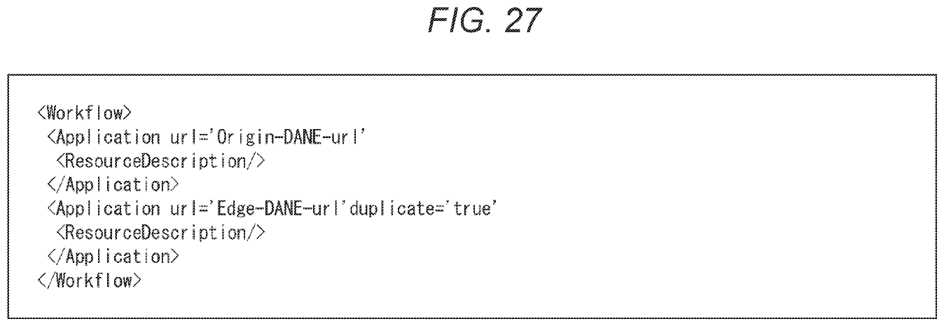

For example, as illustrated in FIG. 27, it is assumed that this redundant configuration can be specified when a duplicate attribute of an Application element of a target application is set to ‘true’ in the Workflow Description.

### Information Processing System in Second Embodiment

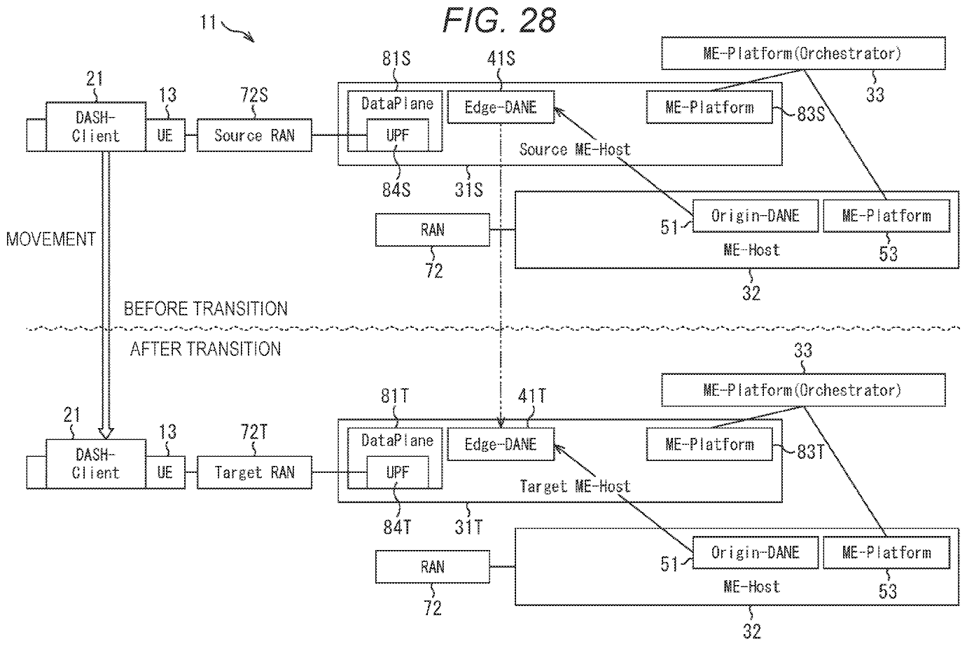

A pre-change of the cache state of an Edge-DANE 41 based on a traffic prediction in an information processing system 11 in a second embodiment will be described with reference to FIGS. 28 to 32. For example, the information processing system 11 in the second embodiment is characterized in that, when the environment of an ME-Host 31 changes due to an inter-base station handover of a DASH-Client 21, the cache state can be changed in advance on the basis of the traffic prediction when the cache state of the Edge-DANE 41 before transition is duplicated in advance.

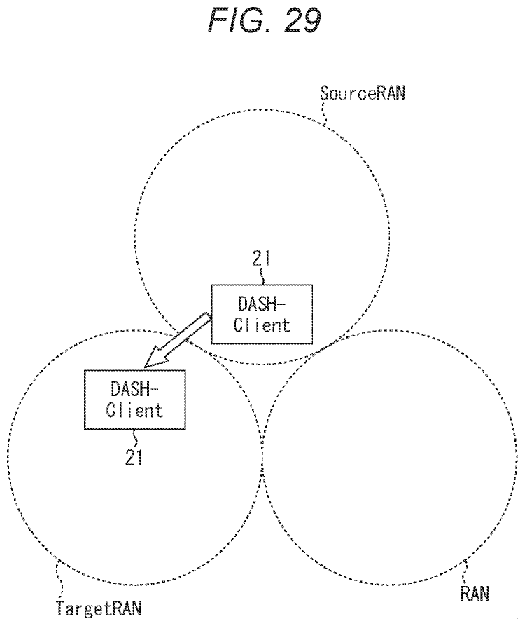

For example, FIG. 28 illustrates states before and after the transition accompanying the occurrence of the inter-base station handover due to the movement of the DASH-Client 21 from a Source RAN 72S to a Target RAN 72T (see FIG. 29).

For example, it is assumed that an Edge-DANE 41T executed on an ME-Host 31T bound to the Target RAN 72T as a transition destination detects in advance the possibility that session resources equivalent to those of a session before the transition cannot be secured. In this case, the optimum cache state in anticipation of a change in stream quality after the transition is configured in advance in the Edge-DANE 41T after the transition. Furthermore, in a case where a cache capacity is not sufficient, the optimization is performed within the limit.

Here, the synchronous prefetching request in the processing in a case where the transition destination cell (RAN 72) cannot be predicted as described above with reference to FIG. 20, the processing of ensuring the fault tolerance redundancy as described above with reference to FIG. 24, and the like can be replaced with a synchronous adaptive prefetching request described below.

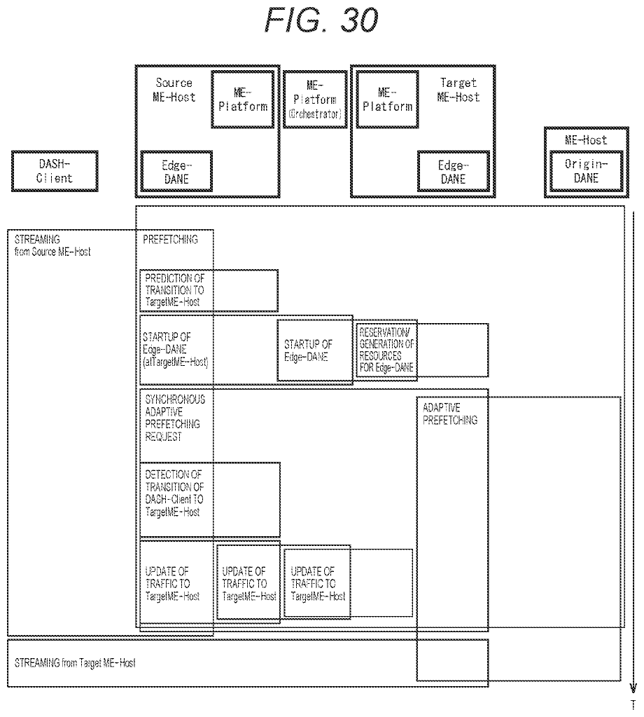

The processing performed at this time is illustrated in a flow of FIG. 30. Note that, in the flow illustrated in FIG. 30, processing similar to that in the flow of FIG. 13 is performed except that the synchronous prefetching request in the flow of FIG. 13 is replaced with the synchronous adaptive prefetching request and then adaptive prefetching is performed, and detailed description thereof will be omitted.

Here, the synchronous adaptive prefetching request will be described.

For example, as described above, an Edge-DANE 41S on a Source ME-Host 31S streaming to the DASH-Client 21 before the transition detects the possibility that the DASH-Client 21 may transition to the Target RAN 72T bound to the Target ME-Host 31T. In response to this, after starting up the Edge-DANE 41T on the Target ME-Host 31T, the synchronous adaptive prefetching request is made to the Edge-DANE 41T.

Furthermore, in the adaptive prefetching, the Edge-DANE 41T predicts segments expected to be acquired in the future and voluntarily prefetches the segments. In addition, in the adaptive prefetching, it is assumed that the current traffic state in the Target RAN 72T and the state of resources for calculation, storage, and the like in the Target ME-Host 31T are considered, and the segments expected to be acquired in the future are prefetched in advance in anticipation of restrictions on a reasonable streaming session that is assumed in a case where the DASH-Client 21 transitions to the Target RAN 72T in the future.

Furthermore, the session resources currently established on the Source ME-Host 31S may not be secured depending on the current traffic and the state of resources for calculation, storage, and the like in the Target RAN 72T or the traffic and the state of resources for calculation, storage, and the like predicted in the future after the DASH-Client 21 transitions. Therefore, in a case where the environment is poorer than the current one, segments expected to be acquired in the future are prefetched for a Representation that consumes less resources (for example, having a lower bit rate) among Representations of an AdaptationSet currently being reproduced. Note that, in some cases, the Representation may be selected from a Representation group in a certain AdaptationSet, or, in other cases, the AdaptationSet itself may be changed. Thus, for example, it is possible to adaptively select segments with a different stream quality (high bit rate or low bit rate) on the basis of the traffic prediction in the transition destination.

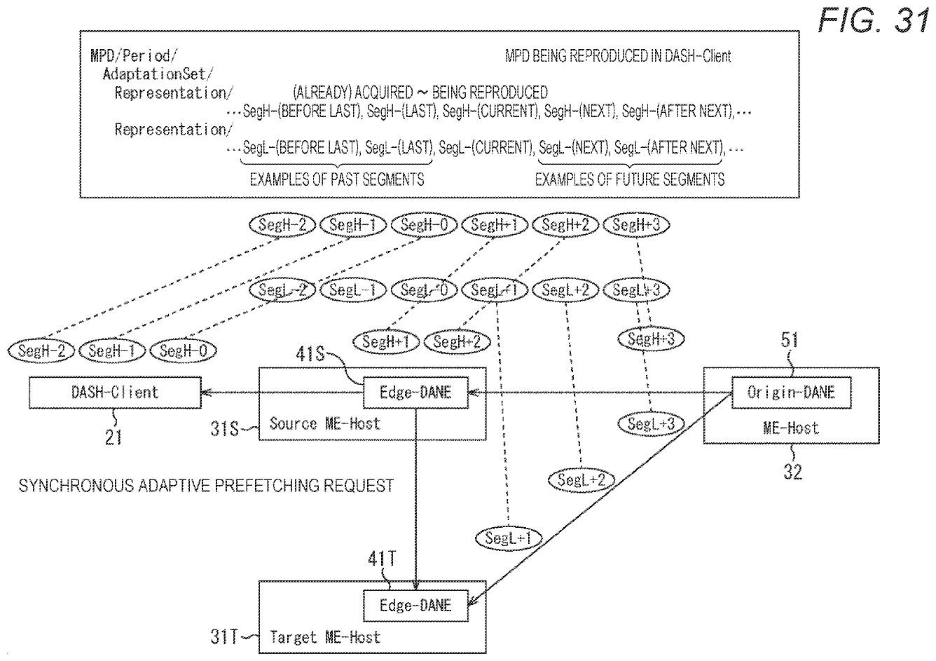

FIG. 31 illustrates a segment flow when such a synchronous adaptive prefetching request serves as a trigger to start the prefetching.

For example, as illustrated, both a segment sequence of a Representation of the AdaptationSet currently being reproduced and a segment sequence of a Representation of an AdaptationSet with a lower bit rate (having the optimized attributes for the resource state in the future) are available.

Then, the synchronous adaptive prefetching request serves as a trigger to start to prefetch segments of different Representations of the same AdaptationSet, which will be required later than a current segment Seg−0. That is, as illustrated, future segments of the Representation of the AdaptationSet with the lower bit rate (SegL+1, SegL+2, SegL+3, . . . ) start to be transmitted to the Edge-DANE 41T in synchronization with transmission of future segments of the Representation of the current AdaptationSet (SegH+1, SegH+2, SegH+3, . . . ) from the Origin-DANE 51 to the Edge-DANE 41S.

Note that this adaptive prefetching is started when it is confirmed that session resources different from the current session resources via the Source ME-Host 31S are secured in the environment via the Target ME-Host 31T. In addition, it is assumed that system clock synchronization is performed between the Source ME-Host 31S and the Target ME-Host 31T by a network time protocol (NTP) or the like, and the same Wallclock is shared.

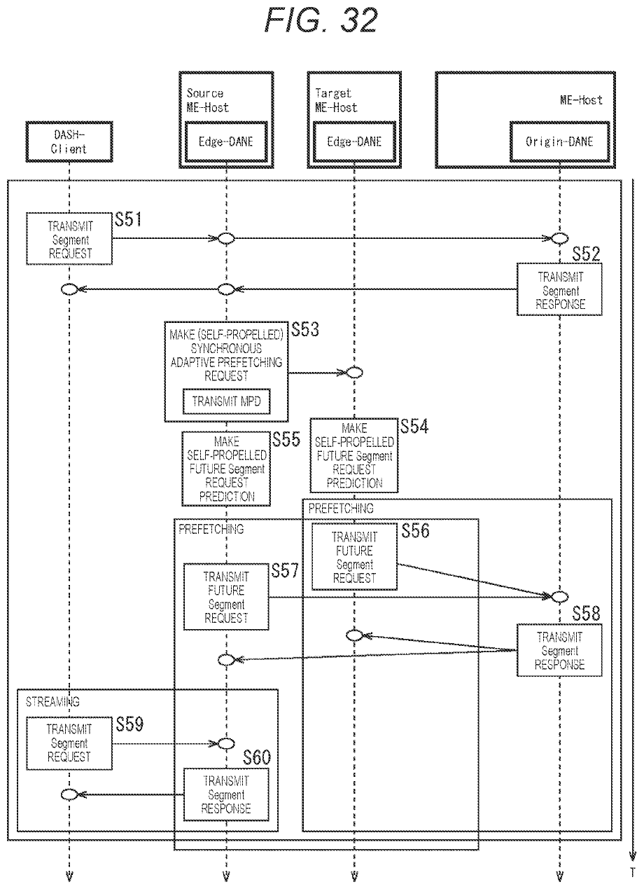

FIG. 32 is a flowchart for describing processing of starting the streaming in a case where the Edge-DANE 41S and the Edge-DANE 41T predict the segments expected to be acquired in the future and voluntarily perform the adaptive prefetching.

For example, in steps S51 and S52, processing similar to that in steps S41 and S42 of FIG. 16 is performed. Then, in step S53, the Edge-DANE 41S transmits an MPD to the Edge-DANE 41T and makes the (self-propelled) synchronous adaptive prefetching request to synchronize the adaptive prefetching with the Edge-DANE 41T.

After that, in steps S54 and S55, processing similar to that in steps S44 and S45 of FIG. 16 is performed.

Then, the adaptive prefetching between the Edge-DANE 41T and the Origin-DANE 51 in step S56 and a subsequent step and the prefetching between the Edge-DANE 41S and the Origin-DANE 51 in step S57 and a subsequent step are performed synchronously.

As described above, when the Edge-DANE 41T performs the adaptive prefetching, for example, the cache state can be changed in advance on the basis of the traffic prediction, and the streaming can be performed at a bit rate according to the traffic after the transition.

Messaging protocols for the synchronous prefetching request and the synchronous adaptive prefetching request will be described below.

For example, the messaging protocols for the synchronous prefetching request and the synchronous adaptive prefetching request from the Edge-DANE 41S on the Source ME-Host 31S before the transition to the Edge-DANE 41T on the Target ME-Host 31T as a transition destination can be defined by extending a DASH-SAND.

Then, a PrefetchTriggerRequest message is introduced as a SAND-PED message between the Edge-DANEs 41. For example, a PrefetchTriggerRequest element has an adaptivePrefetch attribute that indicates whether the prefetching is adaptive or not, a relayedSANDMessageFromDASHClient attribute that stores a SAND message from the Edge-DANE 41S on the Source ME-Host 31S, and a theStream element that identifies segments of a target stream.

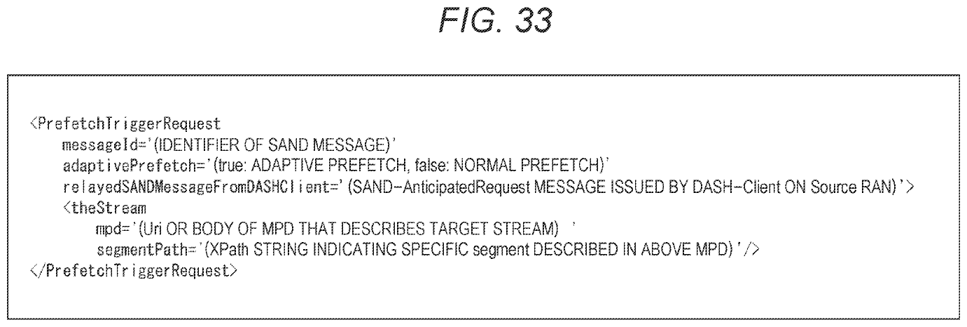

FIG. 33 illustrates an example of a structure of a PrefetchTriggerRequest.

For example, the adaptivePrefetch attribute indicates that the normal prefetching is performed with a value of false and the adaptive prefetching is performed with a value of true.

Furthermore, the relayedSANDMessageFromDASHClient attribute can also store, for example, a SAND-AnticipatedRequest message, which is a SAND message issued by the DASH-Client 21 to the Edge-DANE 41S in step S33 of FIG. 15 described above to inform the Edge-DANE 41S of a set of segments that may be acquired in the near future.

In addition, the theStream element has an mpd attribute that stores a reference to the MPD (url of the MPD) containing attributes of a stream to be controlled or an MPD body, and a segmentPath attribute that stores an XPath string indicating a specific segment described in the MPD.

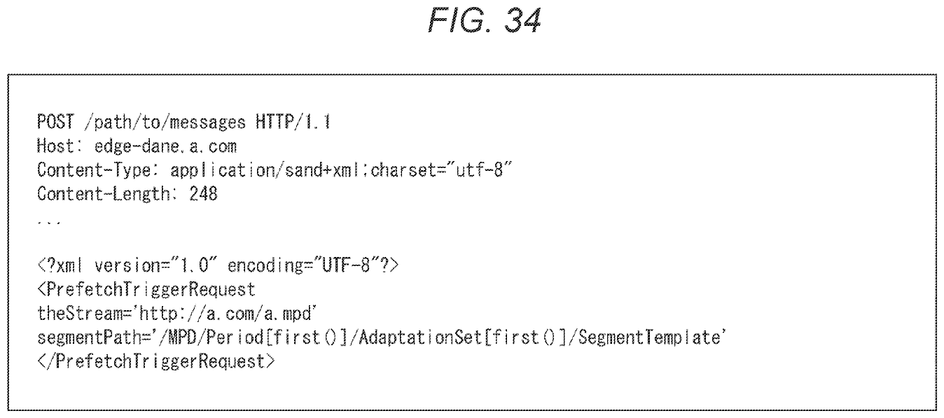

Here, the PrefetchTriggerRequest message is transferred to the Edge-DANE 41S on the Source ME-Host 31S or the Edge-DANE 41T on the Target ME-Host 31T by use of, for example, HTTP-POST as illustrated in FIG. 34.

FIG. 34 also illustrates an example of a segment specified by a SegmentTemplate element of a first AdaptationSet element of a first period element of an mpd specified by a url of http://a.com/a.mpd.

### Configuration Example of Computer

Next, the series of processing (information processing method) described above can be performed by hardware or software. In a case where the series of processing is performed by software, a program constituting the software is installed on a general-purpose computer or the like.

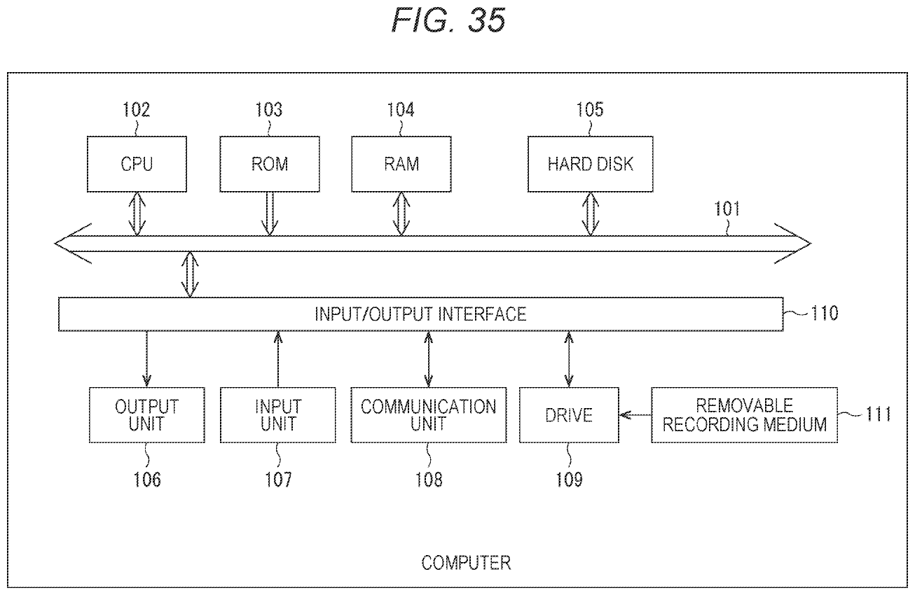

FIG. 35 is a block diagram illustrating a configuration example of an embodiment of a computer on which the program for executing the above-described series of processing is installed.

The program can be recorded in advance on a hard disk 105 or a ROM 103 as a recording medium incorporated in the computer.

Alternatively, the program can be stored (recorded) in a removable recording medium 111 driven by a drive 109. The removable recording medium 111 as described above can be provided as so-called package software. Here, examples of the removable recording medium 111 include a flexible disk, a compact disc read only memory (CD-ROM), a magneto optical (MO) disk, a digital versatile disc (DVD), a magnetic disk, a semiconductor memory, and the like.

Note that the program can be installed on the computer from the removable recording medium 111 as described above, or can be downloaded to the computer via a communication network or a broadcasting network and installed on the incorporated hard disk 105. That is, for example, the program can be transferred wirelessly from a download site to the computer via an artificial satellite for digital satellite broadcasting, or transferred by wire to the computer via a network such as a local area network (LAN) or the Internet.

The computer incorporates a central processing unit (CPU) 102, and an input/output interface 110 is connected to the CPU 102 via a bus 101.

When a command is input by a user operating an input unit 107 via the input/output interface 110, for example, the CPU 102 executes the program stored in the read only memory (ROM) 103 according to the command. Alternatively, the CPU 102 loads the program stored in the hard disk 105 into a random access memory (RAM) 104 and executes the program.

As a result, the CPU 102 performs the processing according to the above-described flowcharts or the processing performed according to the configurations of the above-described block diagrams. The CPU 102 then outputs, if necessary, a processing result from an output unit 106, transmits the processing result from a communication unit 108, or records the processing result on the hard disk 105, for example, via the input/output interface 110.

Note that the input unit 107 includes a keyboard, a mouse, a microphone, and the like. Furthermore, the output unit 106 includes a liquid crystal display (LCD), a speaker, and the like.

Here, in the present specification, the processing performed by the computer according to the program does not necessarily have to be performed in time series in the orders described as the flowcharts. That is, the processing performed by the computer according to the program also includes processing executed in parallel or individually (for example, parallel processing or processing by an object).

Furthermore, the program may be processed by one computer (processor) or may be distributed to and processed by a plurality of computers. Moreover, the program may be transferred to and executed by a distant computer.

Furthermore, in the present specification, a system means a set of a plurality of components (devices, modules (parts), and the like), and it does not matter whether or not all the components are in the same housing. Therefore, a plurality of devices housed in separate housings and connected via a network, and one device in which a plurality of modules is housed in one housing are both systems.

Furthermore, for example, the configuration described as one device (or processing unit) may be divided and configured as a plurality of devices (or processing units). On the contrary, the configurations described above as a plurality of devices (or processing units) may be collectively configured as one device (or processing unit). Furthermore, needless to say, a configuration other than the configuration described above may be added to the configuration of each device (or each processing unit). Moreover, a part of the configuration of a certain device (or processing unit) may be included in the configuration of another device (or another processing unit) if the configuration and operation of the entire system are substantially the same.

Furthermore, for example, the present technology can have a cloud computing configuration in which one function is shared and jointly processed by a plurality of devices via a network.

In addition, for example, the above-described program can be executed in any device. In this case, the device is only required to have necessary functions (functional blocks or the like) so that necessary information can be obtained.

Furthermore, for example, each step described in the above-described flowcharts can be executed by one device or shared and executed by a plurality of devices. Moreover, in a case where one step includes a plurality of sets of processing, the plurality of sets of processing included in the one step can be executed by one device or shared and executed by a plurality of devices. In other words, the plurality of sets of processing included in one step can be executed as a plurality of steps processing. On the contrary, the processing described as a plurality of steps can also be collectively executed as one step.

Note that, in the program executed by the computer, the processing of the steps describing the program may be executed in time series in the order described in the present specification, executed in parallel, or executed individually at a required timing such as when a call is made. That is, as long as there is no contradiction, the processing of each step may be executed in an order different from the above-described order. Moreover, the processing of the steps describing the program may be executed in parallel with processing of another program, or may be executed in combination with processing of another program.

Note that the plurality of present technologies described in the present specification can be carried out independently from each other and alone as long as there is no contradiction. Needless to say, any plurality of the present technologies can be used in combination. For example, a part or all of the present technology described in any of the embodiments may be carried out in combination with a part or all of the present technology described in another embodiment. Furthermore, it is also possible to carry out a part or all of any of the above-described present technologies in combination with another technology not described above.

### Combination Example of Configurations

Note that the present technology may have the following configurations.

(1)

An information processing device including

a first delivery terminal that streams content to a client terminal via a first network, in which

the first delivery terminal makes a synchronous prefetching request to request pre-reading synchronized with the first delivery terminal to a second delivery terminal that streams the content to the client terminal via a second network when a handover from the first network to the second network occurs due to a movement of the client terminal.

(2)

The information processing device according to (1), in which

the client terminal predicts a segment that may be acquired in a near future, the first delivery terminal receives a request for the predicted segment, and transmits, to the second delivery terminal, the request and a media presentation description (MPD), which is a file in which metadata of the content is described, to make the synchronous prefetching request, and

the first delivery terminal and the second delivery terminal refer to the MPD and the request and acquire the segment predicted by the client terminal in advance.

(3)

The information processing device according to (1), in which

the first delivery terminal transmits, to the second delivery terminal, a media presentation description (MPD), which is a file in which metadata of the content is described, to make the synchronous prefetching request, and

the first delivery terminal and the second delivery terminal refer to the MPD, predict a segment that may be acquired by the client terminal in a near future, and acquire the predicted segment in advance.

(4)

The information processing device according to any of (1) to (3), in which

in a case where the first delivery terminal predicts that the client terminal will transition to the second network, the first delivery terminal causes a host device bound to the second network to start up the second delivery terminal.

(5)

The information processing device according to (4), in which

in a case where the host device bound to the second network fails to start up the second delivery terminal, the content is streamed to the client terminal via the second network while the first delivery terminal is maintained.

(6)

The information processing device according to (4), in which

in a case where the second network as a transition destination of the client terminal is not able to be predicted, a plurality of the host devices is caused to start up the second delivery terminal.

(7)

The information processing device according to (4), in which

in a case where a plurality of the second networks overlaps at a transition destination of the client terminal, each of the host devices bound to corresponding one of the second networks is caused to start up the second delivery terminal.

(8)

The information processing device according to any of (1) to (7), in which

when the first delivery terminal makes the synchronous prefetching request to the second delivery terminal, a segment having a different stream quality is adaptively selected on the basis of a traffic prediction of the second network.

(9)

An information processing method performed by an information processing device including a first delivery terminal that streams content to a client terminal via a first network, the information processing method including

making, by the first delivery terminal, a synchronous prefetching request to request pre-reading synchronized with the first delivery terminal to a second delivery terminal that streams the content to the client terminal via a second network when a handover from the first network to the second network occurs due to a movement of the client terminal.

(10)

A program that causes a computer of an information processing device including a first delivery terminal that streams content to a client terminal via a first network to execute information processing including

making, by the first delivery terminal, a synchronous prefetching request to request pre-reading synchronized with the first delivery terminal to a second delivery terminal that streams the content to the client terminal via a second network when a handover from the first network to the second network occurs due to a movement of the client terminal.

Note that the present embodiments are not limited to the above-described embodiments, and various modifications can be made without departing from the gist of the present disclosure. Furthermore, the effects described in the present specification are merely examples and are not limited, and other effects may be obtained.

### REFERENCE SIGNS LIST

11 Information processing system

### 12 Cloud

13 User terminal

### 21 DASH-Client

### 31 and 32 ME-Host

### 33 ME-Platform (Orchestrator)

### 41 Edge-DANE

42 Database holding unit
43 Storage unit

### 51 Origin-DANE

52 Storage unit
61 Database holding unit
71 5G core network system
72 Access network
81 Data plane

### 82 Application

### 83 ME-Platform

### 84 UPF

1. An information processing device comprising
a first delivery terminal that streams content to a client terminal via a first network, wherein
the first delivery terminal makes a synchronous prefetching request to request pre-reading synchronized with the first delivery terminal to a second delivery terminal that streams the content to the client terminal via a second network when a handover from the first network to the second network occurs due to a movement of the client terminal.

2. The information processing device according to claim 1, wherein
the client terminal predicts a segment that may be acquired in a near future, the first delivery terminal receives a request for the predicted segment, and transmits, to the second delivery terminal, the request and a media presentation description (MPD), which is a file in which metadata of the content is described, to make the synchronous prefetching request, and
the first delivery terminal and the second delivery terminal refer to the MPD and the request and acquire the segment predicted by the client terminal in advance.

3. The information processing device according to claim 1, wherein
the first delivery terminal transmits, to the second delivery terminal, a media presentation description (MPD), which is a file in which metadata of the content is described, to make the synchronous prefetching request, and
the first delivery terminal and the second delivery terminal refer to the MPD, predict a segment that may be acquired by the client terminal in a near future, and acquire the predicted segment in advance.

4. The information processing device according to claim 1, wherein
in a case where the first delivery terminal predicts that the client terminal will transition to the second network, the first delivery terminal causes a host device bound to the second network to start up the second delivery terminal.

5. The information processing device according to claim 4, wherein
in a case where the host device bound to the second network fails to start up the second delivery terminal, the content is streamed to the client terminal via the second network while the first delivery terminal is maintained.

6. The information processing device according to claim 4, wherein
in a case where the second network as a transition destination of the client terminal is not able to be predicted, a plurality of the host devices is caused to start up the second delivery terminal.

7. The information processing device according to claim 4, wherein
in a case where a plurality of the second networks overlaps at a transition destination of the client terminal, each of the host devices bound to corresponding one of the second networks is caused to start up the second delivery terminal.

8. The information processing device according to claim 1, wherein
when the first delivery terminal makes the synchronous prefetching request to the second delivery terminal, a segment having a different stream quality is adaptively selected on a basis of a traffic prediction of the second network.

9. An information processing method performed by an information processing device including a first delivery terminal that streams content to a client terminal via a first network, the information processing method comprising
making, by the first delivery terminal, a synchronous prefetching request to request pre-reading synchronized with the first delivery terminal to a second delivery terminal that streams the content to the client terminal via a second network when a handover from the first network to the second network occurs due to a movement of the client terminal.

10. A program that causes a computer of an information processing device including a first delivery terminal that streams content to a client terminal via a first network to execute information processing including
making, by the first delivery terminal, a synchronous prefetching request to request pre-reading synchronized with the first delivery terminal to a second delivery terminal that streams the content to the client terminal via a second network when a handover from the first network to the second network occurs due to a movement of the client terminal.
